(19) United States
(12) Patent Application Publication
(10) Pub. No.: US 2023/0396655 A1
(43) Pub. Date: Dec. 7, 2023

(54) EFFICIENT AUTHENTICATION INFORMATION EXCHANGE BETWEEN NODES IN A 5G COMPLIANT NETWORK

(71) Applicant: Telefonaktiebolaget LM Ericsson (publ), Stockholm (SE)

(72) Inventors: Maria Cruz Bartolome RODRIGO, Torremocha de Jarama Madrid (ES); Christine JOST, Dalby (SE)

(73) Assignee: Telefonaktiebolaget LM Ericsson (publ), Stockholm (SE)

(21) Appl. No.: 18/033,684

(22) PCT Filed: Feb. 15, 2021
(86) PCT No.: PCT/EP2021/053684

§ 371 Date: Apr. 25, 2023

(30) Foreign Application Priority Data
Oct. 26, 2020 (EP) 20382929.6

(51) Int. Cl. H04L 9/40; H04L 67/51; H04L 67/56

(52) U.S. Cl. CPC H04L 63/205; H04L 67/51; H04L 67/56

(57) ABSTRACT

There is provided a method for handling a service request. The method is performed by a first network node. The first network node is a first network function (NF) node of a service consumer or a first service communication proxy (SCP) node that is configured to operate as an SCP between the first NF node and one or more second NF nodes of a service producer. Transmission of a first request is initiated and/or a response to the first request is received (102). The first request is for a second NF node of the one or more second NF nodes to provide a first service requested by the first NF node. The first request has a first security feature only if such a first security feature is required. The response to the first request has a second security feature only if such a second security feature is required.

### TECHNICAL FIELD

The disclosure relates to methods for handling a service request in a network and nodes configured to operate in accordance with those methods.

### BACKGROUND

There exist various techniques for handling a request for a service in a network. A service request is generally from a consumer of the service (“service consumer”) to a producer of the service (“service producer”). For example, a service request may be from a network function (NF) node of a service consumer to an NF node of a service producer. The NF node of the service consumer and the NF node of the service producer can communicate directly or indirectly. This is referred to as direct communication and indirect communication respectively. In the case of indirect communication, the NF node of the service consumer and the NF node of the service producer may communicate via a service communication proxy (SCP) node.

FIG. 1A-D illustrates different existing systems for handling service requests, as set out in 3GPP TS 23.501 v16.4.0. In more detail, FIGS. 1A and 1B illustrates a system that uses direct communication, while FIGS. 10 and 1D illustrates a system that uses indirect communication.

In the systems illustrated in FIGS. 1A and 1B, a service request is sent directly from the NF node of the service consumer to the NF node of the service producer. A response to the service request is sent directly from the NF node of the service producer to the NF node of the service consumer. Similarly, any subsequent service requests are sent directly from the NF node of the service consumer to the NF node of the service producer. The system illustrated in FIG. 1B also comprises a network repository function (NRF). Thus, in the system illustrated in FIG. 1B, the NF node of the consumer can query the NRF to discover suitable NF nodes of the service producer to which to send the service request. In response to such a query, the NF node of the consumer can receive an NF profile for one or more NF nodes of the service producer and, based on the received NF profile(s) can select an NF node of the service producer to which to send the service request. In the system illustrated in FIG. 1A, the NRF is not used and instead the NF node of the consumer may be configured with the NF profile(s) of the NF node(s) of the service producer.

In the systems illustrated in FIGS. 10 and 1D, a service request is sent indirectly from the NF node of the service consumer to the NF node of the service producer via a service communication proxy (SCP) node. A response to the service request is sent indirectly from the NF node of the service producer to the NF node of the service consumer via the SCP. Similarly, any subsequent service requests are sent indirectly from the NF node of the service consumer to the NF node of the service producer via the SCP. The systems illustrated in FIG. 1C and D also comprise an NRF.

In the system illustrated in FIG. 1C, the NF node of the consumer can query the NRF to discover suitable NF nodes of the service producer to which to send the service request. In response to such a query, the NF node of the consumer can receive an NF profile for one or more NF nodes of the service producer and, based on the received NF profile(s) can select an NF node of the service producer to which to send the service request. In this case, the service request sent from the NF node of the service consumer to the SCP comprises the address of the selected NF node of the service producer. The NF node of the service consumer can forward the service request without performing any further discovery or selection. In case the selected NF node of the service producer is not accessible for any reason, it may be up to the NF node of the service consumer to find an alternative. In other cases, the SCP may communicate with the NRF to acquire selection parameters (e.g. location, capacity, etc.) and the SCP may select an NF node of the service producer to which to send the service request.

In the system illustrated in FIG. 1D, the NF node of the consumer does not carry out the discovery or selection process. Instead, the NF node of the consumer adds any necessary discovery and selection parameters (required to find a suitable NF node of the service producer) to the service request that it sends via the SCP. The SCP uses the request address and the discovery and selection parameters in the service request to route the service request to a suitable NF node of the service producer. The SCP can perform discovery with the NRF.

For the fifth generation core (5GC), from Release 16, the SCP is included as a network element to allow indirect communication between an NF node of a service consumer and an NF node of a service producer. The indirect communication that is used can be either of the two indirect communications options described earlier with reference to FIGS. 10 and 1D.

FIG. 2 is a signalling diagram illustrating an exchange of signals in an existing system, such as the system illustrated in FIG. 1D but it will be understood the issue described can also apply to the system illustrated in FIG. 1C. The system illustrated in FIG. 2 comprises a first SCP node 10, a first NF node 20 of a service consumer (“NFc”), and a second NF node 30 of a service producer (“NFp”). The first SCP node 10 is configured to operate as an SCP between the first NF node 20 and the second NF node 30. The second NF node 30 can be configured to run a service. The second NF node 30 can be part of a set of NF nodes of a service producer. The system illustrated in FIG. 2 also comprises a network repository function (NRF) node 60.

FIG. 2 relates to a service request, which may be for a specific user equipment (UE)/session context. As illustrated by arrow 200 of FIG. 2, the first NF node 20 initiates transmission of the service request towards the first SCP node 10. Herein, this service request may be referred to as the “first request” 200. The first request 200 is for an NF node of a service producer to provide a first service requested by the first NF node 20. As illustrated in FIG. 2, the first request 200 comprises a client credentials assertion for the first NF node 20 as defined in 3GPP TS 33.501 v16.4.0. The first NF node 20 may know via which SCP node to route the first request 200 by configuration or other means. The first request 200 comprises the address of this SCP node. In this illustration, this SCP node is the first SCP node 10. The discovery parameters may be included in the first request 200. For example, the first request 200 can comprise a hypertext transfer protocol (HTTP) header that identifies the parameters to be used for discovery and selection.

As illustrated by arrow 202 of FIG. 2, a discovery process is performed between the first SCP node 10 and the NRF node 60. For example, the discovery process can involve the first SCP node 10 initiating transmission of a discovery request towards the NRF node 60 to obtain NF profile(s) of one or more NF nodes of the service producer for the service that needs to be executed. The discovery request comprises the received discovery parameters. The discovery process can also involve the first SCP node 10 receiving a response from the NRF node 60 comprising the NF profile(s) of one or more NF nodes of the service producer. Although not illustrated in FIG. 2, the first SCP node 10 may store the NF profile(s) of one or more NF nodes of the service producer. Although also not illustrated in FIG. 2, the first SCP node 10 may select one NF node of the service producer from the one(s) discovered using, for example, functional criteria (e.g. subscription permanent identifier (SUPI), network slice selection assistance information (NSSAI), data network name (DNN), etc.) and/or non-functional criteria (e.g. load, capacity, etc.). For the purpose of the illustration, it is assumed that the first SCP node 10 selects the second NF node 30.

As illustrated by arrow 204 of FIG. 2, the first SCP node 10 initiates transmission of a request towards the NRF node 60 for an access token. This request may be referred to herein as an “access token request”. As illustrated in FIG. 2, the request 204 for the access token comprises the client credentials assertion received in the first request 200. As illustrated by block 206 of FIG. 2, the NRF node 60 authenticates and validates the client credentials assertion using any suitable method, such as that described in 3GPP TS 33.501 v16.4.0.

As illustrated by arrow 208 of FIG. 2, the NRF node 60 initiates transmission of a response to the request for an access token towards the first SCP node 10. This response may be referred to herein as an “access token response”. If the authentication at block 206 of FIG. 2 is successful and the first NF node 20 is authorised (e.g. based on a policy stored at the NRF node 60), the response 208 to the request for the access token comprises the access token (as illustrated in FIG. 2). The NRF node 60 may issue the access token as described in 3GPP TS 33.501 v16.4.0. The NRF node 60 can use an identifier (e.g. instance identifier) of the first NF node 20 as the subject of the access token. On the other hand, if the authentication at block 206 of FIG. 2 is unsuccessful, the response may instead be indicative that the authentication is unsuccessful.

Although not illustrated in FIG. 2, the first SCP node 10 may replace its own address (namely, the scp-address) in the received first request 200 with the address of the second NF node 30. The first SCP node 10 may perform any extra functionality, such as monitoring and/or tracing. As illustrated by arrow 210 of FIG. 2, the first SCP node 10 initiates transmission of the first request towards the second NF node 30. The first request 210 is for the second NF node 30 to provide the first service requested by the first NF node 20. As illustrated in FIG. 2, the first request 210 comprises the client credentials assertion and the access token. As illustrated by block 212 of FIG. 2, the second NF node 30 authenticates the access token by one of the method described in 3GPP TS 33.501 v16.4.0. If the authentication is successful, the access token is validated as described in 3GPP TS 33.501 v16.4.0.

As illustrated by arrow 214 of FIG. 2, the second NF node 30 initiates transmission of a response to the first request towards the first SCP node 10 and thus the first SCP node 10 receives the response. Herein, this response may be referred to as the “first response” 214. The response 214 can comprise the result (e.g. that the first request is successful if the validation of the access token is successful) and optionally also some business logic (BL) information (e.g. as a result of providing the service). As illustrated by arrow 216 of FIG. 2, the first SCP node 10 initiates transmission of the response towards the first NF node 20.

In indirect communication scenarios, the second NF node 30 and the first NF node 20 use implicit authentication by relying on authentication between the first NF node 20 and the first SCP node 10, and between the first SCP node 10 and the second NF node 30, provided by a transport layer protection solution or physical security. If a public land mobile network (PLMN) uses token-based authorisation as described in 3GPP TS 33.501 v16.4.0 and the PLMN's policy mandates that the NRF node 60 authenticates the first NF node 20 before granting an access token, the access token indicates to the second NF node 30 that the first NF node 20 has been authenticated by the NRF node 60. If additional authentication of the first NF node 20 is required, the second NF node 30 authenticates the second NF node 30 at the application layer using client credentials assertion and authentication described in 3GPP TS 33.501 v16.4.0. Thus, in existing techniques, the first NF node 20 always needs to include the client credentials assertion in case the second NF node 30 may require it. This can waste resources, and be costly and inefficient.

### SUMMARY

It is an object of the disclosure to obviate or eliminate at least some of the above-described disadvantages associated with existing techniques.

Therefore, according to an aspect of the disclosure, there is provided a method for handling a service request in a network. The method is performed by a first network node. The first network node is a first network function (NF) node of a service consumer or a first service communication proxy (SCP) node that is configured to operate as an SCP between the first NF node and a second NF node of a service producer. The method comprises initiating transmission of a first request. The first request is for the second NF node to provide a first service requested by the first NF node. The first request has a first security feature only if such a first security feature is required. Alternatively or in addition, the method comprises receiving a response to the first request. The response to the first request has a second security feature only if such a second security feature is required.

In some embodiments, the first security feature and the second security feature may be the same or the first security feature and the second security feature may be different.

In some embodiments, the first security feature may be that the first request comprises at least one first security parameter and/or at least part of the first request may be protected by a first security protocol. In some embodiments, the second security feature may be that the response to the first request comprises at least one second security parameter and/or at least part of the response to the first request may be protected by a second security protocol.

In some embodiments, the at least one first security parameter may comprise at least one first security token and/or the first security protocol may be encryption and/or integrity protection. In some embodiments, the at least one second security parameter may comprise at least one second security token and/or the second security protocol may be encryption and/or integrity protection.

In some embodiments, the at least one first security token may comprise at least one first client credentials assertion and/or at least one first access token. In some embodiments, the at least one second security token may comprise at least one second client credentials assertion and/or at least one second access token.

In some embodiments, the first and/or second security feature may be required by the first SCP node, a group of SCP nodes comprising the first SCP node, the second NF node, a group of NF nodes of the service producer comprising the second NF node, a network repository function (NRF) node, and/or any other node.

In some embodiments, the first security feature may be required by the second NF node for the first request and/or the first security feature may be required by the NRF node for a request for the NRF node to provide an access token.

In some embodiments, the first and/or second security feature may be required for all services, any service requested by the first NF node, the first service requested by the first NF node, a group of services comprising the first service requested by the first NF node, or services that are outside a predefined location and the first service is outside the predefined location.

In some embodiments, the first and/or second security feature may be required for all NF nodes of the service consumer, the first NF node of the service consumer, a group of NF nodes of the service consumer comprising the first NF node of the service consumer, or any NF nodes of the service consumer that are outside a predefined location and the first NF node (20) of the service consumer is outside the predefined location.

In some embodiments, the first request may have the first security feature if a profile of the second NF node comprises information indicative that such a first security feature is required and/or if the first NF node is configured in a predefined way that requires the first security feature. In some embodiments, the response to the first request may have the second security feature if a profile of the second NF node comprises information indicative that such a second security feature is required.

In some embodiments, the first request may be an initial request for the second NF node to provide the first service requested by the first NF node or a subsequent request for the second NF node to provide the first service requested by the first NF node.

In some embodiments, the method may comprise checking whether such a first and/or second security feature is required and/or receiving a message comprising information indicative of whether such a first and/or second security feature is required.

In some embodiments, the message may comprise information indicative of one or more nodes that require such a first and/or second security feature.

In some embodiments, the method may be performed by the first NF node, the first request may be the subsequent request for the second NF node to provide the first service requested by the first NF node, and the message may be a response to an earlier request for the second NF node to provide the first service requested by the first NF node.

In some embodiments, the method may be performed by the first SCP node and the message may be a response to a request for a network repository function (NRF) node to provide an access token.

In some embodiments, the method may comprise, if such a first and/or second security feature is required, acquiring the first and/or second security feature.

In some embodiments, the first and/or second security feature may be acquired from a network repository function (NRF) node.

In some embodiments, the method may comprise initiating storage of information indicative of whether such a first and/or second security feature is required.

In some embodiments, the first SCP node and the first NF node may be deployed in independent deployment units and/or the first SCP node and the second NF node may be deployed in independent deployment units.

In some embodiments, the first SCP node may be deployed as a distributed network element.

In some embodiments, part of the first SCP node may be deployed in the same deployment unit as the first NF node and/or part of the first SCP node may be deployed in the same deployment unit as the second NF node.

In some embodiments, at least one second SCP node may be configured to operate as an SCP between the first NF node and the first SCP node, and/or at least one third SCP node may be configured to operate as an SCP between the first SCP node and the second NF node.

In some embodiments, the first SCP node and one or both of the at least one second SCP node and the at least one third SCP node may be deployed in independent deployment units.

In some embodiments, the at least one second SCP node and/or the at least one third SCP node may be deployed as distributed network elements.

In some embodiments, an entity may comprise the first SCP node and a network repository function (NRF) node.

According to another aspect of the disclosure, there is provided a first NF node comprising processing circuitry configured to operate in accordance with the method described earlier in respect of the first NF node.

In some embodiments, the first NF node may comprise at least one memory for storing instructions which, when executed by the processing circuitry, cause the first NF node to operate in accordance with the method described earlier in respect of the first NF node.

According to another aspect of the disclosure, there is provided a first network node comprising processing circuitry configured to operate in accordance with the method described earlier in respect of the first network node. In some embodiments, the first network node may comprise at least one memory for storing instructions which, when executed by the processing circuitry, cause the first network node to operate in accordance with the method described earlier in respect of the first network node.

According to another aspect of the disclosure, there is provided a method for handling a service request in a network. The method is performed by a second NF node of a service producer. The method comprises receiving a first request for the second NF node to provide a service requested by a first NF node of a service consumer. The first request has a first security feature only if such a first security feature is required. Alternatively or in addition, the method comprises initiating transmission of a response to the first request towards a first network node. The first network node is the first NF node or a first service communication proxy (SCP) node that is configured to operate as an SCP between the first NF node and the second NF node. The response to the first request has a second security feature only if such a second security feature is required.

In some embodiments, the first security feature and the second security feature may be the same or the first security feature and the second security feature may be different.

In some embodiments, the response to the first request may be indicative of whether the first request is allowed.

In some embodiments, the first request may be allowed provided that the first security feature of the first request is accepted by the second NF node.

In some embodiments, the method may comprise checking whether the first request is accepted by the second NF node.

In some embodiments, the first security feature may be that the first request comprises at least one first security parameter and/or at least part of the first request is protected by a first security protocol. In some embodiments, the second security feature may be that the response to the first request comprises at least one second security parameter and/or at least part of the response to the first request is protected by a second security protocol.

In some embodiments, the at least one first security parameter may comprise at least one first security token and/or the first security protocol may be encryption and/or integrity protection. In some embodiments, the at least one second security parameter may comprise at least one second security token and/or the second security protocol may be encryption and/or integrity protection.

In some embodiments, the at least one first security token may comprise at least one first client credentials assertion and/or at least one first access token. In some embodiments, the at least one second security token may comprise at least one second client credentials assertion and/or at least one second access token.

In some embodiments, the first and/or second security feature may be required by the first SCP node, a group of SCP nodes comprising the first SCP node, the second NF node, a group of NF nodes of the service producer comprising the second NF node, a network repository function (NRF) node, and/or any other node.

In some embodiments, the first security feature may be required by the second NF node for the first request and/or the first security feature may be required by the NRF node for a request for the NRF node to provide an access token.

In some embodiments, the first and/or second security feature may be required for all services, any service requested by the first NF node, the first service requested by the first NF node, a group of services comprising the first service requested by the first NF node, or services that are outside a predefined location and the first service is outside the predefined location.

In some embodiments, the first and/or second security feature may be required for all NF nodes of the service consumer, the first NF node of the service consumer, a group of NF nodes of the service consumer comprising the first NF node of the service consumer, or any NF nodes of the service consumer that are outside a predefined location and the first NF node of the service consumer is outside the predefined location.

In some embodiments, the first request may have the first security feature if a profile of the second NF node comprises information indicative that such a first security feature is required and/or if the first NF node is configured in a predefined way that requires the first security feature. In some embodiments, the response to the first request may have the second security feature if a profile of the second NF node comprises information indicative that such a second security feature is required.

In some embodiments, the first request may be an initial request for the second NF node to provide the first service requested by the first NF node or a subsequent request for the second NF node to provide the first service requested by the first NF node.

In some embodiments, the first SCP node and the first NF node may be deployed in independent deployment units and/or the first SCP node and the second NF node may be deployed in independent deployment units.

In some embodiments, the first SCP node may be deployed as a distributed network element.

In some embodiments, part of the first SCP node may be deployed in the same deployment unit as the first NF node and/or part of the first SCP node may be deployed in the same deployment unit as the second NF node.

In some embodiments, at least one second SCP node may be configured to operate as an SCP between the first NF node and the first SCP node, and/or at least one third SCP node may be configured to operate as an SCP between the first SCP node and the second NF node.

In some embodiments, the first SCP node and one or both of the at least one second SCP node and the at least one third SCP node may be deployed in independent deployment units.

In some embodiments, the at least one second SCP node and/or the at least one third SCP node may be deployed as distributed network elements.

In some embodiments, an entity may comprise the first SCP node and a network repository function (NRF) node.

According to another aspect of the disclosure, there is provided a second network function (NF) node of a service producer. The second NF node comprises processing circuitry configured to operate in accordance with the method described earlier in respect of the second NF node.

In some embodiments, the second NF node may comprise at least one memory for storing instructions which, when executed by the processing circuitry, cause the second NF node to operate in accordance with the method described earlier in respect of the second NF node.

According to another aspect of the disclosure, there is provided a method performed by a system. The method comprises the method as described earlier in respect of the first network node and/or the method described earlier in respect of the second NF node.

According to another aspect of the disclosure, there is provided a system comprising at least one first network node as described earlier and/or at least one second NF node as described earlier.

According to another aspect of the disclosure, there is provided a computer program comprising instructions which, when executed by processing circuitry, cause the processing circuitry to perform the method as described earlier in respect of the first network node and/or second NF node.

According to another aspect of the disclosure, there is provided a computer program product, embodied on a non-transitory machine-readable medium, comprising instructions which are executable by processing circuitry to cause the processing circuitry to perform the method as described earlier in respect of the first network node and/or second NF node.

Thus, an improved technique for handling service requests in a network is provided.

### BRIEF DESCRIPTION OF THE DRAWINGS

For a better understanding of the technique, and to show how it may be put into effect, reference will now be made, by way of example, to the accompanying drawings, in which:

FIG. 1A-D is a block diagram illustrating different existing systems;

FIG. 2 is a signalling diagram illustrating an exchange of signals in an existing system;

FIG. 3 is a block diagram illustrating a first network node according to an embodiment;

FIG. 4 is a flowchart illustrating a method performed by a first network node according to an embodiment;

FIG. 5 is a block diagram illustrating a second network function node according to an embodiment;

FIG. 6 is a flowchart illustrating a method performed by a second network function node according to an embodiment;

FIG. 7 is a signalling diagram illustrating an exchange of signals in a system according to an embodiment;

FIG. 8 is a signalling diagram illustrating an exchange of signals in a system according to an embodiment;

FIG. 9 is a signalling diagram illustrating an exchange of signals in a system according to an embodiment;

FIG. 10 is a signalling diagram illustrating an exchange of signals in a system according to an embodiment;

FIG. 11 is a signalling diagram illustrating an exchange of signals in a system according to an embodiment;

FIG. 12 is a block diagram illustrating a first network node according to an embodiment; and

FIG. 13 is a block diagram illustrating a second network function node according to an embodiment.

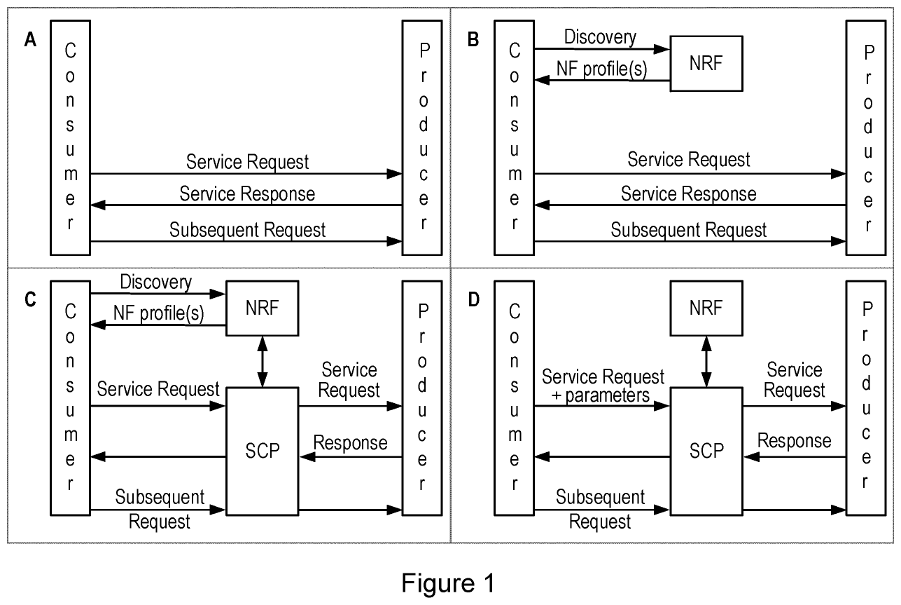

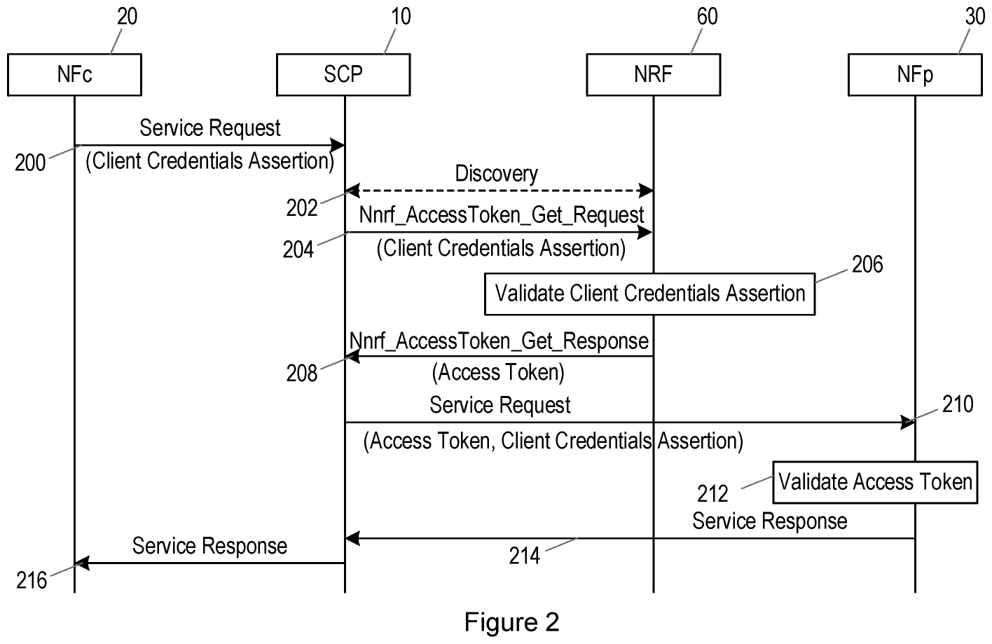

### DETAILED DESCRIPTION

Herein, techniques for handling a service request in a network are described. A service request can also be referred to as a request for a service. Generally, a service is software intended to be managed for users. Herein, a service can be any type of service, such as a communication service, a context management (e.g. user equipment context management (UECM)) service, a data management (DM) service, or any other type of service. The techniques described herein can be used in respect of any network, such as any communications network. The network may be a fifth generation (5G) network or any other generation network. In some embodiments, the network may be a core network or a radio access network (RAN). The techniques are implemented by a first network node and a second network function (NF) node.

An NF is a third generation partnership project (3GPP) adopted or 3GPP defined processing function in a network, which has defined functional behaviour and 3GPP defined interfaces. An NF can be implemented either as a network element on a dedicated hardware, as a software instance running on a dedicated hardware, or as a virtualised function instantiated on an appropriate platform, e.g. on a cloud infrastructure. Herein, the term “node” in relation to an “NF node” will be understood to cover each of these scenarios.

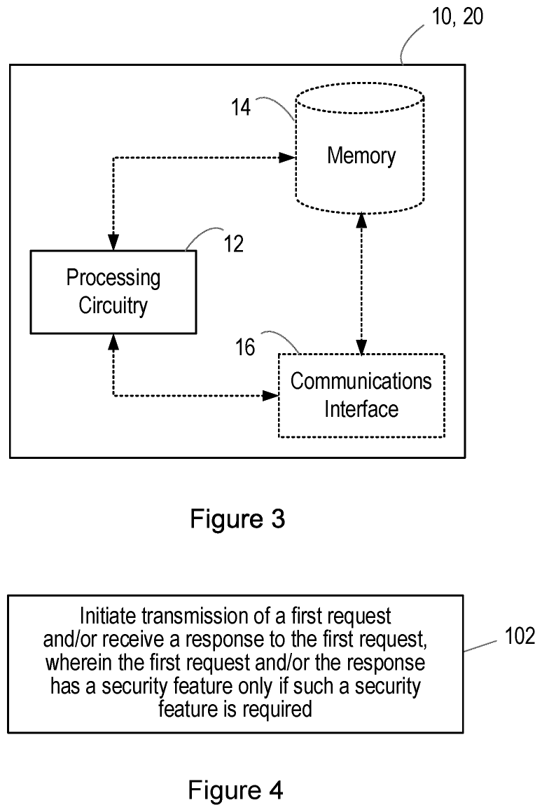

FIG. 3 illustrates a first network node 10, 20 in accordance with an embodiment. The first network node 10, 20 is for handling a service request in a network. The first network node 10, 20 can be a first network function (NF) node 20 of a service consumer or a first service communication proxy (SCP) node 10. The first SCP node 10 is configured to operate as an SCP between the first NF node 20 and one or more second NF nodes of a service producer. In some embodiments, the first network node 10, 20 (e.g. the first SCP node 10 and/or the first NF node 20) can, for example, be a physical machine (e.g. a server) or a virtual machine (VM). The first NF node 20 can be, for example, a user equipment (UE).

As illustrated in FIG. 3, the first network node 10 comprises processing circuitry (or logic) 12. The processing circuitry 12 controls the operation of the first network node 10, 20 and can implement the method described herein in respect of the first network node 10, 20. The processing circuitry 12 can be configured or programmed to control the first network node 10, 20 in the manner described herein. The processing circuitry 12 can comprise one or more hardware components, such as one or more processors, one or more processing units, one or more multi-core processors and/or one or more modules. In particular implementations, each of the one or more hardware components can be configured to perform, or is for performing, individual or multiple steps of the method described herein in respect of the first network node 10, 20. In some embodiments, the processing circuitry 12 can be configured to run software to perform the method described herein in respect of the first network node 10, 20. The software may be containerised according to some embodiments. Thus, in some embodiments, the processing circuitry 12 may be configured to run a container to perform the method described herein in respect of the first network node 10, 20.

Briefly, the processing circuitry 12 of the first network node 10, 20 is configured to initiate transmission of a first request. The first request is for a second NF node of the one or more second NF nodes to provide a first service requested by the first NF node. The first request has a first security feature only if such a first security feature is required. Alternatively or in addition, the processing circuitry 12 of the first network node 10, 20 is configured to receive a response to the first request. The response to the first request has a second security feature only if such a second security feature is required.

As illustrated in FIG. 3, in some embodiments, the first network node 10, 20 may optionally comprise a memory 14. The memory 14 of the first network node 10, 20 can comprise a volatile memory or a non-volatile memory. In some embodiments, the memory 14 of the first network node 10, 20 may comprise a non-transitory media. Examples of the memory 14 of the first network node 10, 20 include, but are not limited to, a random access memory (RAM), a read only memory (ROM), a mass storage media such as a hard disk, a removable storage media such as a compact disk (CD) or a digital video disk (DVD), and/or any other memory.

The processing circuitry 12 of the first network node 10, 20 can be connected to the memory 14 of the first network node 10, 20. In some embodiments, the memory 14 of the first network node 10, 20 may be for storing program code or instructions which, when executed by the processing circuitry 12 of the first network node 10, 20, cause the first network node 10, 20 to operate in the manner described herein in respect of the first network node 10, 20. For example, in some embodiments, the memory 14 of the first network node 10, 20 may be configured to store program code or instructions that can be executed by the processing circuitry 12 of the first network node 10, 20 to cause the first network node 10, 20 to operate in accordance with the method described herein in respect of the first network node 10, 20. Alternatively or in addition, the memory 14 of the first network node 10, 20 can be configured to store any information, data, messages, requests, responses, indications, notifications, signals, or similar, that are described herein. The processing circuitry 12 of the first network node 10, 20 may be configured to control the memory 14 of the first network node 10, 20 to store information, data, messages, requests, responses, indications, notifications, signals, or similar, that are described herein.

In some embodiments, as illustrated in FIG. 3, the first network node 10, 20 may optionally comprise a communications interface 16. The communications interface 16 of the first network node 10, 20 can be connected to the processing circuitry 12 of the first network node 10, 20 and/or the memory 14 of first network node 10, 20. The communications interface 16 of the first network node 10, 20 may be operable to allow the processing circuitry 12 of the first network node 10, 20 to communicate with the memory 14 of the first network node 10, 20 and/or vice versa. Similarly, the communications interface 16 of the first network node 10, 20 may be operable to allow the processing circuitry 12 of the first network node 10, 20 to communicate with the second NF node, a network function repository node, and/or any other node. In embodiments where the first network node is the first SCP node 10, the communications interface 16 of the first SCP node 10 may be operable to allow the processing circuitry 12 of the first SCP node 10 to communicate with the first NF node 20. Similarly, in embodiments where the first network node is the first NF node 20, the communications interface 16 of the first NF node 20 may be operable to allow the processing circuitry 12 of the first NF node 20 to communicate with the first SCP node 10. The communications interface 16 of the first network node 10, 20 can be configured to transmit and/or receive information, data, messages, requests, responses, indications, notifications, signals, or similar, that are described herein. In some embodiments, the processing circuitry 12 of the first network node 10, 20 may be configured to control the communications interface 16 of the first network node 10, 20 to transmit and/or receive information, data, messages, requests, responses, indications, notifications, signals, or similar, that are described herein.

Although the first network node 10, 20 is illustrated in FIG. 3 as comprising a single memory 14, it will be appreciated that the first network node 10, 20 may comprise at least one memory (i.e. a single memory or a plurality of memories) 14 that operate in the manner described herein. Similarly, although the first network node 10, 20 is illustrated in FIG. 3 as comprising a single communications interface 16, it will be appreciated that the first network node 10, 20 may comprise at least one communications interface (i.e. a single communications interface or a plurality of communications interface) 16 that operate in the manner described herein. It will also be appreciated that FIG. 3 only shows the components required to illustrate an embodiment of the first network node 10, 20 and, in practical implementations, the first network node 10, 20 may comprise additional or alternative components to those shown.

FIG. 4 is a flowchart illustrating a method performed by a first network node 10, 20 in accordance with an embodiment. As mentioned earlier, the first network node 10, 20 can be the first NF node 20, or the first SCP node 10 that is configured to operate as an SCP between the first NF node 20 and the one or more second NF nodes. The method is for handling a service request in the network. The first network node 10, 20 described earlier with reference to FIG. 3 is configured to operate in accordance with the method of FIG. 4. The method can be performed by or under the control of the processing circuitry 12 of the first network node 10, 20.

As illustrated at block 102 of FIG. 4, transmission of a first request is initiated and/or a response to such a first request is received. As mentioned earlier, the term “initiate” can mean, for example, cause or establish. Thus, the processing circuitry 12 of the first network node 10, 20 can be configured to itself transmit the first request (e.g. via a communications interface 16 of the first network node 10, 20) or can be configured to cause another node to transmit the first request. The first request is for a second NF node of the one or more second NF nodes to provide a first service requested by the first NF node. It will be understood that this second NF node may be any NF node of the service producer, e.g. an NF node of the service producer selected by the first SCP node 10 or the first NF node 20. Thus, in some embodiments where the first network node 10, 20 is the first NF node 20, the first service request may not specify a specific second NF node as this may be selected by the first SCP node 10. Instead, in these embodiments, the first service request can be for any second NF node to provide the first service. The first request has a first security feature only if such a first security feature is required and/or the response to the first request has a second security feature only if such a second security feature is required. Thus, in the manner described herein, the first network node (e.g. the first NF node 20 and/or the first SCP node 10) only employs a security feature when it is actually required.

Herein, the first security feature and the second security feature may be the same, or the first security feature and the second security feature may be different. In some embodiments described herein, the first security feature may be that the first request comprises at least one first security parameter and/or at least part of the first request protected by a first security protocol. Alternatively or in addition, in some embodiments described herein, the second security feature may be that the response to the first request comprises at least one second security parameter and/or at least part of the response to the first request is protected by a second security protocol. In some embodiments described herein, the at least one first security parameter may comprise at least one first security token, and/or the first security protocol may be encryption and/or integrity protection. Alternatively or in addition, in some embodiments described herein, the at least one second security parameter may comprise at least one second security token, and/or the second security protocol may be encryption and/or integrity protection.

In some embodiments described herein, the at least one first security token may comprise at least one first assertion (e.g. client credentials assertion) and/or at least one first access token. Alternatively or in addition, in some embodiments described herein, the at least one second security token may comprise at least one second assertion (e.g. client credentials assertion) and/or at least one second access token. A client credentials assertion can, for example, be a token signed by the first NF node 20. It enables the first NF node 20 to authenticate itself towards a receiving end point (e.g. the first SCP node 10 and/or the second NF node). In some embodiments, a client credentials assertion (CCA) can include an identifier that identifies the first NF node 20 and this identifier can be checked against a certificate by the first NF node 20. Herein, a client credentials assertion may also be referred to as a client assertion.

The first and/or second security feature referred to herein may be required by any node or, more specifically, a network node. For example, the first and/or second security feature referred to herein may be required by the first SCP node 10, a group (or set) of SCP nodes comprising the first SCP node 10, the second NF node 30, a group (or set) of NF nodes of the service producer comprising the second NF node 30, the NRF node and/or any other node (e.g. an external node). Thus, any one or more nodes may be in charge of setting the first and/or second security features referred to herein. In some embodiments, the first and/or second security feature referred to herein may be required by the NF nodes of the service producer (e.g. the second NF node 30) accessible via a particular SCP node (e.g. the first SCP node 10) or a particular group of SCP nodes (e.g. comprising the first SCP node 10). In some embodiments, the first SCP node 10 and/or the NRF node 60 may be provided with the functionality to overwrite one or more security features in a profile of the second NF node 30, e.g. depending on other security criteria. The first security feature referred to herein may be required by the second NF node 30 for the first request and/or the first security feature referred to herein may be required by the NRF node 60 for a request for the NRF node 60 to provide a security feature, such as an access token.

The first and/or second security feature referred to herein may be required for all services, any service requested by the first NF node 20, the first service requested by the first NF node 20, a group (or set) of services comprising the first service requested by the first NF node 20, or services that are outside a predefined location and the first service is outside the predefined location. The first and/or second security feature referred to herein may be required for all NF nodes of the service consumer, the first NF node 20 of the service consumer, a group (or set) of NF nodes of the service consumer comprising the first NF node 20 of the service consumer, or any NF nodes of the service consumer that are outside a predefined location and the first NF node 20 of the service consumer is outside the predefined location.

In some embodiments, the first request referred to herein may have the first security feature if a profile of the second NF node comprises information indicative that such a first security feature is required and/or if the first NF node 20 is configured in a predefined way (e.g. a predefined mode, such as in an indirect communications mode or any other communications mode) that requires the first security feature. Thus, in some embodiments, the inclusion of the first security feature in the first request may be locally configured at the first NF node 20 (e.g. based on the indirect communication mode). Alternatively or in addition, in some embodiments, the response to the first request referred to herein may have the second security feature if a profile of the second NF node comprises information indicative that such a second security feature is required. In some embodiments, the profile of the second NF node may comprise information indicative that the first and/or second security feature is required for the first NF node 20 to access its services. This may be indicated at service level (service profile) or at NF profile level (that is, applicable for all the services). The first NF node 20 and/or the first SCP node 10 can be configured to read one or more NF profiles to check whether the first and/or second security feature is required.

In some embodiments, client credentials assertion may be required for requesting an access token from an NRF node and/or to access the second NF node 30. This may be configured in one or more NF profiles. In some embodiments, the second NF node may require the usage of token-based authorisation for invoking its services and/or the usage of integrity protection for invoking its services. This information may be configured in the NF profile of the second NF node. The requirement may, for example, be per service.

In some embodiments, the first request referred to herein may be an initial request for the second NF node to provide the first service requested by the first NF node 20. In other embodiments, the first request referred to herein may be a subsequent request for the second NF node to provide the first service requested by the first NF node 20.

Although not illustrated in FIG. 4, in some embodiments, the method may comprise checking whether such a first and/or second security feature is required, and/or receiving a message comprising information indicative of whether such a first and/or second security feature is required. In some embodiments in which the method is performed by the first NF node 20 and the first request is the subsequent request for the second NF node to provide the first service requested by the first NF node 20, the message may be a response to an earlier request for the second NF node to provide the first service requested by the first NF node 20. In some embodiments in which the method is performed by the first SCP node 10, the message may be a response to a request for the NRF node to provide a security feature, such as an access token.

In some embodiments, this message may comprise information indicative of one or more nodes that require such a first and/or second security feature. The information may be referred to as the “audience” and it can identify the node(s) for which the first and/or second security feature applies. For example, the information may be indicative that the NRF node 60 and/or the second NF node 30 require such a first and/or second security feature. In some embodiments, the same security feature may be valid for more than one node such that only one security feature is needed. However, different security features are also possible. In some embodiments, this may depend on whether a security feature is required from the first NF node 20 to the first SCP node 10 only (e.g. for the first SCP node 10 to request an access token on behalf of the first NF node 20), and/or whether a security feature is required from the first SCP node 10 to the second NF node (e.g. because the second NF node requires the security feature to access certain services).

Although also not illustrated in FIG. 4, in some embodiments, the method may comprise, if such a first and/or second security feature is required, acquiring the first and/or second security feature. For example, in some embodiments, the first and/or second security feature may be acquired from the NRF node. Although also not illustrated in FIG. 4, in some embodiments, the method may comprise initiating storage of information indicative of whether such a first and/or second security feature is required.

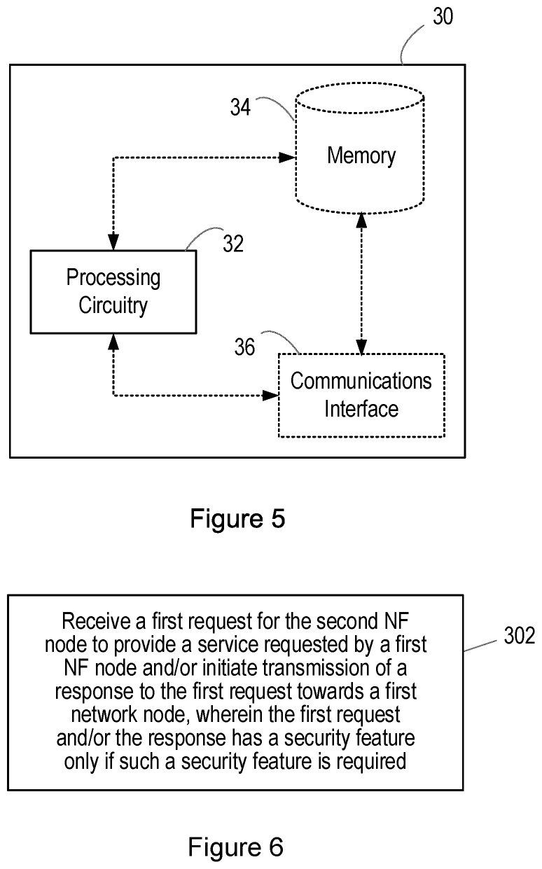

FIG. 5 illustrates a second NF node 30 of a service producer in accordance with an embodiment. The second NF node 30 is for handling a service request in a network. In some embodiments, the second NF node 30 can, for example, be a physical machine (e.g. a server) or a virtual machine (VM).

As illustrated in FIG. 5, the second NF node 30 comprises processing circuitry (or logic) 32. The processing circuitry 32 controls the operation of the second NF node 30 and can implement the method described herein in respect of the second NF node 30. The processing circuitry 32 can be configured or programmed to control the second NF node 30 in the manner described herein. The processing circuitry 32 can comprise one or more hardware components, such as one or more processors, one or more processing units, one or more multi-core processors and/or one or more modules. In particular implementations, each of the one or more hardware components can be configured to perform, or is for performing, individual or multiple steps of the method described herein in respect of the second NF node 30. In some embodiments, the processing circuitry 32 can be configured to run software to perform the method described herein in respect of the second NF node 30. The software may be containerised according to some embodiments. Thus, in some embodiments, the processing circuitry 32 may be configured to run a container to perform the method described herein in respect of the second NF node 30.

Briefly, the processing circuitry 32 of the second NF node 30 is configured to receive a first request for the second NF node 30 to provide a service requested by the first NF node 20 of the service consumer and/or initiate transmission of a response to the first request towards the first network node 10, 20. The first request has a first security feature only if such a first security feature is required and/or the response to the first request has a second security feature only if such a second security feature is required.

As illustrated in FIG. 5, in some embodiments, the second NF node 30 may optionally comprise a memory 34. The memory 34 of the second NF node 30 can comprise a volatile memory or a non-volatile memory. In some embodiments, the memory 34 of the second NF node 30 may comprise a non-transitory media. Examples of the memory 34 of the second NF node 30 include, but are not limited to, a random access memory (RAM), a read only memory (ROM), a mass storage media such as a hard disk, a removable storage media such as a compact disk (CD) or a digital video disk (DVD), and/or any other memory.

The processing circuitry 32 of the second NF node 30 can be connected to the memory 34 of the second NF node 30. In some embodiments, the memory 34 of the second NF node 30 may be for storing program code or instructions which, when executed by the processing circuitry 32 of the second NF node 30, cause the second NF node 30 to operate in the manner described herein in respect of the second NF node 30. For example, in some embodiments, the memory 34 of the second NF node 30 may be configured to store program code or instructions that can be executed by the processing circuitry 32 of the second NF node 30 to cause the second NF node 30 to operate in accordance with the method described herein in respect of the second NF node 30. Alternatively or in addition, the memory 34 of the second NF node 30 can be configured to store any information, data, messages, requests, responses, indications, notifications, signals, or similar, that are described herein. The processing circuitry 32 of the second NF node 30 may be configured to control the memory 34 of the second NF node 30 to store information, data, messages, requests, responses, indications, notifications, signals, or similar, that are described herein.

In some embodiments, as illustrated in FIG. 5, the second NF node 30 may optionally comprise a communications interface 36. The communications interface 36 of the second NF node 30 can be connected to the processing circuitry 32 of the second NF node 30 and/or the memory 34 of second NF node 30. The communications interface 36 of the second NF node 30 may be operable to allow the processing circuitry 32 of the second NF node 30 to communicate with the memory 34 of the second NF node 30 and/or vice versa. Similarly, the communications interface 36 of the second NF node 30 may be operable to allow the processing circuitry 32 of the second NF node 30 to communicate with the first network node 10, 20 (e.g. the first SCP node 10 and/or the first NF node 20), and/or any other node. The communications interface 36 of the second NF node 30 can be configured to transmit and/or receive information, data, messages, requests, responses, indications, notifications, signals, or similar, that are described herein. In some embodiments, the processing circuitry 32 of the second NF node 30 may be configured to control the communications interface 36 of the second NF node 30 to transmit and/or receive information, data, messages, requests, responses, indications, notifications, signals, or similar, that are described herein.

Although the second NF node 30 is illustrated in FIG. 5 as comprising a single memory 34, it will be appreciated that the second NF node 30 may comprise at least one memory (i.e. a single memory or a plurality of memories) 34 that operate in the manner described herein. Similarly, although the second NF node 30 is illustrated in FIG. 5 as comprising a single communications interface 36, it will be appreciated that the second NF node 30 may comprise at least one communications interface (i.e. a single communications interface or a plurality of communications interface) 36 that operate in the manner described herein. It will also be appreciated that FIG. 5 only shows the components required to illustrate an embodiment of the second NF node 30 and, in practical implementations, the second NF node 30 may comprise additional or alternative components to those shown.

FIG. 6 is a flowchart illustrating a method performed by a second NF node 30 in accordance with an embodiment. The method of FIG. 6 is for handling a service request in the network. The second NF node 30 described earlier with reference to FIG. 5 is configured to operate in accordance with the method of FIG. 6. The method can be performed by or under the control of the processing circuitry 32 of the second NF node 30.

As illustrated at block 302 of FIG. 6, a first request is received for the second NF node 30 to provide a service requested by the first NF node 20 of the service consumer and/or transmission of a response to the first request is initiated towards the first network node 10, 20. As mentioned earlier, the term “initiate” can mean, for example, cause or establish. Thus, the processing circuitry 32 of the second NF node 30 can be configured to itself transmit the response (e.g. via a communications interface 36 of the second NF node 30) or can be configured to cause another node to transmit the response. The first request has a first security feature only if such a first security feature is required and/or the response to the first request has a second security feature only if such a second security feature is required.

In some embodiments, the response to the first request can be indicative of whether the first request is allowed. For example, in some embodiments, the first request may be allowed provided that the first security feature of the first request is accepted (or validated) by the second NF node 30. Although not illustrated in FIG. 6, in some embodiments, the method may comprise checking whether the first request is accepted by the second NF node 30.

There is also provided a system. The system can comprise at least one first network node 10, 20 (e.g. at least one first SCP node 10 and/or at least one first NF node 20) as described herein and/or at least one second NF node 30 as described herein. The system may also comprise any one or more of the other nodes mentioned herein.

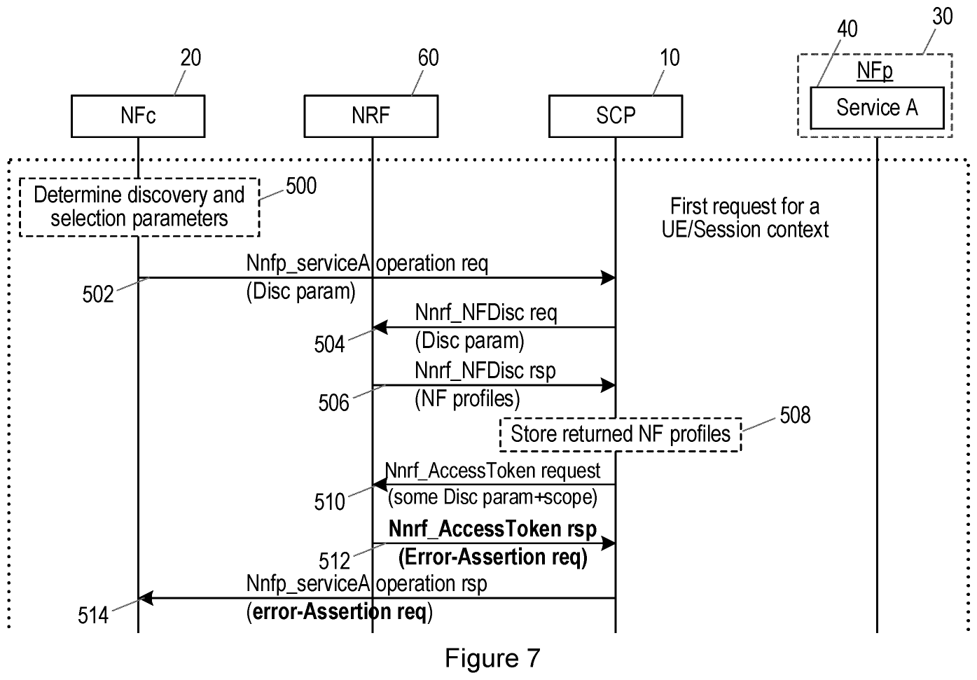

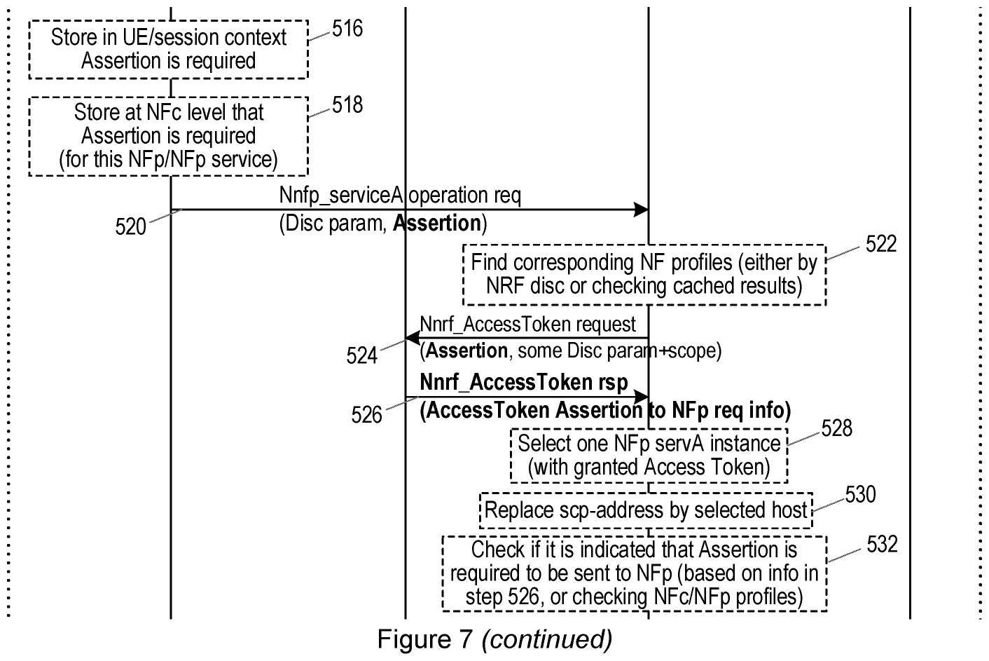

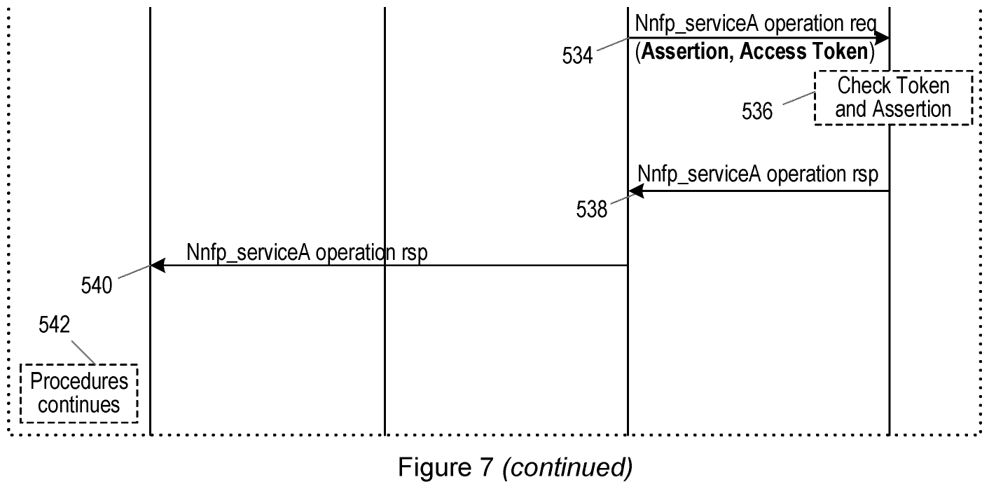

FIG. 7 is a signalling diagram illustrating an exchange of signals in a system according to an embodiment. The system illustrated in FIG. 7 comprises a first SCP node 10, a first NF node 20 of a service consumer (“NFc”), and a second NF node 30 of a service producer (“NFp”). The first SCP node 10 is configured to operate as an SCP between the first NF node 20 and the second NF node 30. Although only a single second NF node 30 is illustrated in FIG. 7, it will be understood that there may be a single second NF node or a plurality of second NF nodes. Thus, the first SCP node 10 can be configured to operate as an SCP between the first NF node 20 and one or more second NF nodes.

The first SCP node 10 and/or the first NF node 20 can be as described earlier with reference to FIGS. 3 and 4. The second NF node 30 can be as described earlier with reference to FIGS. 5 and 6. The second NF node 30 can be configured to run (or provide) a first service 40. In some embodiments, the second NF node 30 can be part of a set (or group) of NF nodes comprising a plurality of NF nodes of the service producer. The system illustrated in FIG. 7 comprises a network repository function (NRF) node 60. In some embodiments, an entity may comprise the first SCP node 10 and the NRF node 60. That is, in some embodiments, the first SCP node 10 can be merged with the NRF node 60 in a combined entity.

In some embodiments, the first SCP node 10 and the first NF node 20 may be deployed in independent deployment units, and/or the first SCP node 10 and the second NF node 30 may be deployed in independent deployment units. Thus, an SCP node based on independent deployment units is possible, as described in 3GPP TS 23.501 V16.4.0. In other embodiments, the first SCP node 10 may be deployed as a distributed network element. For example, in some embodiments, part (e.g. a service agent) of the first SCP node 10 may be deployed in the same deployment unit as the first NF node 20, and/or part (e.g. a service agent) of the first SCP node 10 may be deployed in the same deployment unit as the second NF node 30. Thus, an SCP node based on a service mesh is possible, as described in 3GPP TS 23.501 V16.4.0.

In some embodiments, at least one second SCP node may be configured to operate as an SCP between the first NF node 20 and the first SCP node 10, and/or at least one third SCP node may be configured to operate as an SCP between the first SCP node and the second NF node 30. Thus, a multipath of SCP nodes is possible. In some of these embodiments, the first SCP node 10 and one or more of the at least one second SCP node and the at least one third SCP node may be deployed in independent deployment units. In some embodiments, the at least one second SCP node and/or the at least one third SCP node may be deployed as distributed network elements.

FIG. 7 relates to a request for a service, which may be for a specific user equipment (UE) and/or session context. As illustrated by block 500 of FIG. 7, the first NF node 20 may determine what discovery (and selection) parameters to use for the service request. More specifically, the first NF node 20 may identify the discovery parameters to include in the service request. The discovery parameters can be those that allow the first SCP node 10 to select an NF node of the service producer in embodiments where the SCP node 10 is responsible for this selection. However, in other embodiments, the first NF node 20 may itself select an NF node of the service producer and thus the discovery parameters are not then needed by the first SCP node 10. The discovery parameters can be associated with a certain service in a received request, which is not illustrated in FIG. 7.

As illustrated by arrow 502 of FIG. 7, the first NF node 20 initiates transmission of the service request towards the first SCP node 10. The service request 502 is for an NF node of the service producer to provide a service requested by the first NF node 20. The first NF node 20 may know via which SCP node to route the service request 502 by configuration or other means. The service request 502 can comprise the address of this SCP node. In this illustration, this SCP node is the first SCP node 10. The discovery parameters may be included in the service request 502. For example, the service request 502 can comprise a hypertext transfer protocol (HTTP) header that identifies the parameters to be used for discovery (and selection).

As illustrated by arrows 504 and 506 of FIG. 7, a discovery process can be performed between the first SCP node 10 and the NRF node 60. For example, as illustrated by arrow 504 of FIG. 7, the discovery process can involve the first SCP node 10 initiating transmission of a discovery request towards the NRF node 60 to obtain NF profile(s) of one or more NF nodes of the service producer for the first service that needs to be provided. The discovery request comprises the received discovery parameters. As illustrated by arrow 506 of FIG. 7, the first SCP node 10 receives a response from the NRF node 60 comprising the NF profile(s) of one or more NF nodes of the service producer. As illustrated by block 508 of FIG. 7, the first SCP node 10 may store the NF profile(s) of one or more NF nodes of the service producer. Although not illustrated in FIG. 7, the first SCP node 10 may select one NF node of the service producer from the one(s) discovered using, for example, functional criteria (e.g. subscription permanent identifier (SUPI), network slice selection assistance information (NSSAI), data network name (DNN), etc.) and/or non-functional criteria (e.g. load, capacity, etc.). In other embodiments, the first NF node 20 may itself preform the discovery process and select an NF node of the service producer. For the purpose of the illustration, it is assumed that the second NF node 30 is selected.

As illustrated by arrow 510 of FIG. 7, the first SCP node 10 initiates transmission of a request towards the NRF node 60 for the NRF node 60 to provide an access token. The request 510 transmitted towards the NRF node 60 can comprise some of the discovery parameters mentioned earlier and scope (e.g. one or more services). The discovery parameters that are needed for the NRF node 60 to grant the access token may be known based on the a profile of the second NF node 30 (e.g. the profile of the second NF node 30 may include attributes, such as “allowedPlmns”, that indicate the values that need to be checked to grant an access token). Alternatively or in addition, the discovery parameters that are needed for the NRF node 60 to grant the access token may be configured in the SCP node 10, since they may depend on the deployment (e.g. different authorisation may be required for different locations). The tokens may need to be granted with different granularity, e.g. they may be required at service level and Single-Network Slice Selection Assistance Information (S-NSSAI).

Although not illustrated in FIG. 7, the NRF node 60 may check whether another security feature is required for the NRF node 60 to provide the requested access token. In some embodiments, the NRF node 60 may check whether another security feature is required for an authorisation “context/area” identified in the access token request 510. For example, the check may be based on information provided for one or both of the first NF node 20 and the second NF node 30. In some embodiments, the NRF node 60 may perform the check by checking a profile of the first NF node 20 and/or a profile of the second NF node 30. For example, it may be configured in one or more of these profiles whether a security feature is required. The security feature may be required at different levels (e.g. at NF level to access any service in the second NF node 30, at service level to access some services but not others, etc.), when the second NF node 30 is at a different location to the first NF node 20 (e.g. in which case the profiles of both the first NF node 20 and the second NF node 30 may be checked), and/or to execute some operations for the first service 40. Alternatively or in addition, it may be configured in the NRF node 60 which one or more security features are required for the NRF node 60 to provide the requested access token.

In the embodiment illustrated in FIG. 7, the NRF node 60 identifies that another security feature is required. This required security feature may be referred to herein as a “first security feature”. In the embodiment illustrated in FIG. 7, the required security feature is a client credentials assertion. For example, a profile of the second NF node may comprise information indicative that client credentials assertion is required (e.g. at least for the first service 40 in order for the second NF node 30 to provide it). As illustrated by arrow 512 of FIG. 7, the first SCP node 10 receives a response to the request 510 from the NRF node 60. In the embodiment illustrated in FIG. 7, the response from the NRF node 60 is an error response. This can be a newly defined error, i.e. an error that is not currently defined in the art, which may be specific for the intended purpose. In particular, the response from the NRF node 60 can indicate that another security feature is required for the NRF node 60 to provide the requested security feature, which is the client credentials assertion in the embodiment illustrated in FIG. 7.

As illustrated by arrow 514 of FIG. 7, the first SCP node 10 initiates transmission of a response to the service request 502 towards the first NF node 20. The response 514 to the service request 502 is an error response. In particular, the response 514 to the service request indicates that the client credentials assertion is required. Thus, based on the response 514, the first NF node 20 knows that it has to include the client credentials assertion in subsequent service requests. As illustrated by block 516 of FIG. 7, the first NF node 20 may store information indicative that the client credentials assertion is required, such that it can be included for any subsequent service requests. The information may be stored with the associated UE and/or session context for the service request 502. For example, the information may be stored with other information that is indicative of the UE and/or session to which the service request 502 relates. As illustrated by block 518 of FIG. 7, the first NF node may store the information at NF consumer level and may also include the applicability context, e.g. that the client credentials assertion is required for the selected NF node of the service producer (which in the embodiment illustrated in FIG. 7 is the second NF node 30) and/or for the particular service 40 that is requested by the first NF node 20. In this way, the first NF node 20 can build context data that allows it to include the client credentials assertion in the relevant subsequent service requests, once the client credentials assertion is known by a first interaction.

As illustrated by arrow 520 of FIG. 7, the first NF node 20 initiates transmission of a subsequent request for the second NF node 30 to provide the service 40 requested by the first NF node 20. This subsequent request may be referred to herein as the “first request”. As described earlier, the first request 520 has a first security feature only if such a first security feature is required. In the embodiment illustrated in FIG. 7, such a first security feature is required and thus the first request 520 has the first security feature. That is, in the embodiment illustrated in FIG. 7, the first request 520 comprises the client credentials assertion. The first NF node 20 may include the client credentials assertion in the first request 520 based on the information received at the step illustrated by arrow 514 of FIG. 7, or any previous information that indicates that the client credentials assertion is required (such as the steps illustrated by blocks 516 or 518 following the earlier service request). The first request can also comprise the discovery parameters mentioned earlier.

In the embodiment illustrated in FIG. 7, transmission of the first request 520 is initiated via the first SCP node 10. Thus, the first SCP node 10 receives the first request 520. As illustrated by block 522 of FIG. 7, the first SCP node 10 may find corresponding NF profile(s) of one or more NF nodes of the service producer, e.g. either by discovery with the NRF node 60 as described earlier or by checking the results that may have been stored earlier. As illustrated by arrow 524 of FIG. 7, the first SCP node 10 initiates transmission of a request towards the NRF node 60 for the NRF node 60 to provide a security feature. In the embodiment illustrated in FIG. 7, this security feature is an access token. This time, the request 524 transmitted towards the NRF node 60 comprises the required client credentials assertion. The request 524 transmitted towards the NRF node 60 may also comprise some discovery parameters and scope information.

As illustrated by arrow 526 of FIG. 7, the first SCP node 10 receives a response to the request 524 from the NRF node 60. The response 526 from the NRF node 60 comprises the requested access token. The response 526 from the NRF node 60 may also comprise information indicative that the client credentials assertion is required. For example, the client credentials assertion may be required for an access token request to the NRF node 60 and/or for the first request 520. As illustrated by block 528 of FIG. 7, the first SCP node 10 may select one NF node of the service producer, such as from the one(s) discovered using, for example, functional criteria (e.g. subscription permanent identifier (SUPI), network slice selection assistance information (NSSAI), data network name (DNN), etc.) and/or non-functional criteria (e.g. load, capacity, etc.). In other embodiments, the first NF node 20 may itself select an NF node of the service producer. In other embodiments, the first NF node 20 may select an NF node of the service producer. The selection may be made from the results that correspond to the granted access token. For the purpose of the illustration, it is assumed that the second NF node 30 is selected.

As illustrated by block 530 of FIG. 7, the first SCP node 10 may replace its own address (namely, the scp-address) in the first request 520 with the address of the selected second NF node 30. As illustrated by block 532 of FIG. 7, the first SCP node 10 may check whether the client credentials assertion is required. More specifically, the first SCP node 10 may check whether the client credentials assertion is required by the second NF node 30. The check can be based on the information comprised in the access token response 526 from the NRF node 60, (e.g. if this information is not provided by the access token response 526) a profile of the second NF node 30, and/or a profile of the first NF node 20 (e.g. if client credentials assertion is required for different locations, such as where the first NF node 20 and the second NF node 30 are at different locations). If the response 526 from the NRF node 60 and/or the profile of the second NF node 30 (and/or a profile of the first NF node 20) comprises information indicative such a security feature is required, then the first SCP node 10 knows that the client credentials assertion is required for the first request 520. Alternatively or in addition, the first SCP node 10 may be configured with information that enables identification of whether the second NF node 30 requires client credentials assertion.

As illustrated by arrow 534 of FIG. 7, the first SCP node 10 initiates transmission of the first request towards the second NF node 30. The first request 534 comprises the client credentials assertion since it is required. If it is identified that the client credentials assertion is required (e.g. by the second NF node 30), then it has to be included in the first request 534. Otherwise, it is not included. The first request 534 may also comprise the access token if this is required. As illustrated by block 536 of FIG. 7, the second NF node 30 checks the received security features, namely the client credentials assertion and/or the access token. That is, the second NF node 30 authenticates the received security features. If the authentication is successful, the second NF node 30 accepts (or validates) the received security features.

As illustrated by arrow 538 of FIG. 7, the second NF node 30 initiates transmission of a response to the first request towards the first SCP node 10. The response 538 to the first request can be indicative of whether the first request is allowed. The first request may be allowed provided that one or more of the security features of the first request are accepted (or validated) by the second NF node 30. As illustrated by arrow 540 of FIG. 7, the first SCP node 10 initiates transmission of the response to the first request towards the first NF node 20. In some embodiments, the response 538, 540 to the first request may have a second security feature only if such a second security feature is required. The second security feature can, for example, be the client credentials assertion, the access token, and/or any other security feature. The second NF node 30 or the first SCP node 10 may be responsible for including a second security feature in and/or applying a second security feature to the response. As illustrated by block 542 of FIG. 7, the process may the continue in the usual manner.

In some indirect communication mode embodiments, when the first NF node 20 indicates the selected second NF node 30 to the first SCP node 10, the first NF node 20 can request the access token directly from the NRF node 60. For example, the first NF node 20 may have an interface with the NRF node 60. In this case, the first NF node 20 may, or may not, be required to include the client credentials assertion in the service request. In some indirect communication mode embodiments, when the first NF node 20 does not indicate the selected second NF node 30 to the first SCP node 10 (e.g. because the first NF node 20 does not have access to the NRF node 60), the first NF node 20 is not able to provide the access token to the first SCP node 10, so the first SCP node 10 requests the access token on behalf of the first NF node 20. In this case, it may be recommended the client credentials assertion is included by the first NF node in the service request, e.g. so that the SCP node 10 can prove that it is the first NF node 20 on behalf of which the first SCP node 10 is requesting the access token. In some indirect communication mode embodiments, when the first NF node 20 has access to the NRF node 60 but decides to delegate initial selection to the first SCP node 10, the first NF node 20 may not be required to include the client credentials assertion in the service request.

Thus, as mentioned earlier, the requirement for the first NF node 20 to provide client credentials assertion in the service request may be identified from a profile of the first NF node 20 and/or a profile of the second NF node 30 but may alternatively be determined by a configuration of the first NF node 20, such as the communication mode. For example, when the first NF node 20 performs indirect communication with delegated discovery, it may be preferable to include the client credentials assertion.

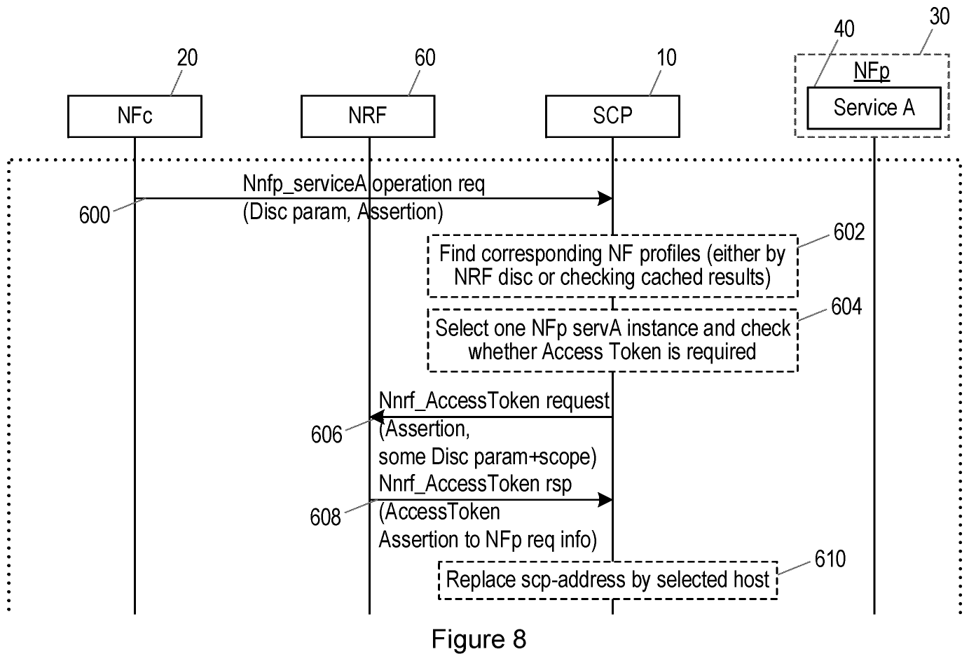

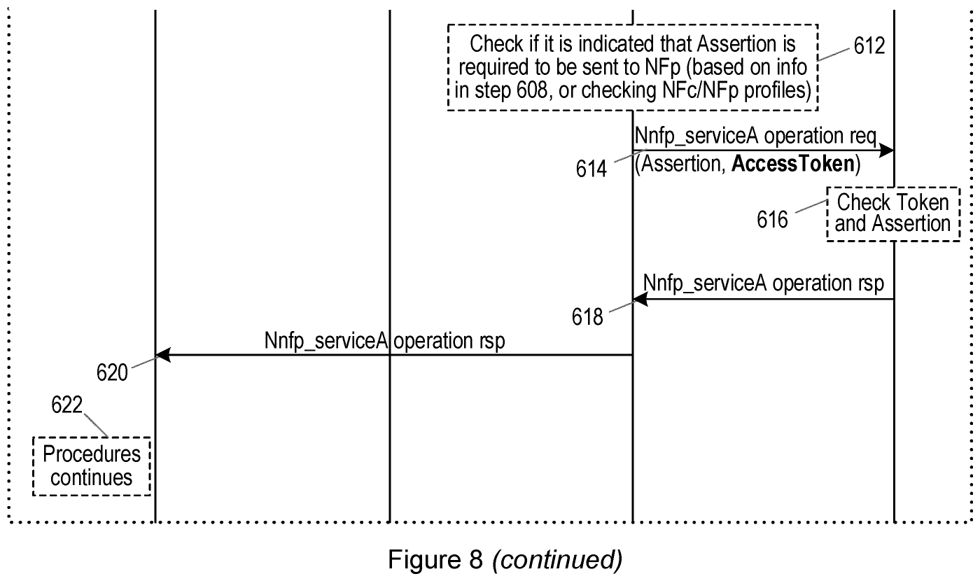

FIG. 8 is a signalling diagram illustrating an exchange of signals in a system according to an embodiment. The system illustrated in FIG. 8 comprises a first SCP node 10, a first NF node 20 of a service consumer (“NFc”), and a second NF node 30 of a service producer (“NFp”). The first SCP node 10 is configured to operate as an SCP between the first NF node 20 and the second NF node 30. Although only a single second NF node 30 is illustrated in FIG. 8, it will be understood that there may be a single second NF node or a plurality of second NF nodes. Thus, the first SCP node 10 can be configured to operate as an SCP between the first NF node 20 and one or more second NF nodes.

The first SCP node 10 and/or the first NF node 20 can be as described earlier with reference to FIGS. 3 and 4. The second NF node 30 can be as described earlier with reference to FIGS. 5 and 6. The second NF node 30 can be configured to run (or provide) a first service 40. In some embodiments, the second NF node 30 can be part of a set (or group) of NF nodes comprising a plurality of NF nodes of the service producer. The system illustrated in FIG. 8 comprises a network repository function (NRF) node 60. In some embodiments, an entity may comprise the first SCP node 10 and the NRF node 60. That is, in some embodiments, the first SCP node 10 can be merged with the NRF node 60 in a combined entity.

In some embodiments, the first SCP node 10 and the first NF node 20 may be deployed in independent deployment units, and/or the first SCP node 10 and the second NF node 30 may be deployed in independent deployment units. Thus, an SCP node based on independent deployment units is possible, as described in 3GPP TS 23.501 V16.4.0. In other embodiments, the first SCP node 10 may be deployed as a distributed network element. For example, in some embodiments, part (e.g. a service agent) of the first SCP node 10 may be deployed in the same deployment unit as the first NF node 20, and/or part (e.g. a service agent) of the first SCP node 10 may be deployed in the same deployment unit as the second NF node 30. Thus, an SCP node based on a service mesh is possible, as described in 3GPP TS 23.501 V16.4.0.

In some embodiments, at least one second SCP node may be configured to operate as an SCP between the first NF node 20 and the first SCP node 10, and/or at least one third SCP node may be configured to operate as an SCP between the first SCP node and the second NF node 30. Thus, a multipath of SCP nodes is possible. In some of these embodiments, the first SCP node 10 and one or more of the at least one second SCP node and the at least one third SCP node may be deployed in independent deployment units. In some embodiments, the at least one second SCP node and/or the at least one third SCP node may be deployed as distributed network elements.

FIG. 8 relates to a request for a service, which may be for a specific user equipment (UE) and/or session context. As illustrated by arrow 600 of FIG. 8, the first NF node initiates transmission of the service request towards the first SCP node 10. The service request 600 is for an NF node of the service producer to provide a service requested by the first NF node 20. The first NF node 20 may know via which SCP node to route the service request 600 by configuration or other means. The service request 600 can comprise the address of this SCP node. In this illustration, this SCP node is the first SCP node 10. The discovery parameters described earlier with reference to FIG. 7 may be included in the service request 600. For example, the service request 600 can comprise a hypertext transfer protocol (HTTP) header that identifies the parameters to be used for discovery (and selection).

As illustrated by block 602 of FIG. 8, the first SCP node 10 may find corresponding NF profile(s) of one or more NF nodes of the service producer, e.g. either by discovery with the NRF node 60 as described earlier with reference to FIG. 7 or by checking the results that may have been stored earlier. As illustrated by block 604 of FIG. 8, the first SCP node 10 may select one NF node of the service producer, such as from the one(s) discovered using, for example, functional criteria (e.g. subscription permanent identifier (SUPI), network slice selection assistance information (NSSAI), data network name (DNN), etc.) and/or non-functional criteria (e.g. load, capacity, etc.). However, in other embodiments, the first NF node 20 may itself select an NF node of the service producer. The selection may be made from the results that correspond to the granted access token. For the purpose of the illustration, it is assumed that the second NF node 30 is selected. As also illustrated by block 604 of FIG. 8, the first SCP node 10 may check whether a security feature is required, e.g. by the second NF node 30 (such as from a profile of the second NF node 30), for all NF nodes of the service consumer (or at least the first NF node 20), and/or for all services (or at least the first service 40). In the embodiment illustrated in FIG. 8, a security feature is required and this security feature is an access token.

Thus, as illustrated by arrow 606 of FIG. 8, the first SCP node 10 initiates transmission of a request towards the NRF node 60 for the NRF node 60 to provide the access token. The request 606 transmitted towards the NRF node 60 may also comprise some discovery parameters and scope information. As illustrated by arrow 608 of FIG. 8, the first SCP node 10 receives a response to the request 606 from the NRF node 60. The response 608 from the NRF node 60 comprises the requested access token. The response 608 from the NRF node 60 may also comprise information indicative that another security feature is required. In the embodiment illustrated in FIG. 8, this security feature is a client credentials assertion. However, in other embodiments, client credentials assertion may not be required.

As illustrated by block 610 of FIG. 8, the first SCP node 10 may replace its own address (namely, the scp-address) in the service request 600 with the address of the selected second NF node 30. As illustrated by block 612 of FIG. 8, the first SCP node 10 may check whether the client credentials assertion is required. More specifically, the first SCP node 10 may check whether the client credentials assertion is required by the second NF node 30. The check can be based on the information comprised in the access token response 608 from the NRF node 60, a profile of the second NF node 30, and/or a profile of the first NF node 20. If the response 608 from the NRF node 60 and/or the profile of the second NF node 30 (and/or a profile of the first NF node 20) comprises information indicative that such a security feature is required, then the first SCP node 10 knows that the client credentials assertion is required for the service request. Alternatively or in addition, the first SCP node 10 may be configured with information that enables identification of whether the second NF node 30 requires the client credentials assertion.

As illustrated by arrow 614 of FIG. 8, the first SCP node 10 initiates transmission of the service request towards the second NF node 30. This service request is referred to herein as the “first request”. The first request 614 comprises the client credentials assertion if it is required. If it is identified that the client credentials assertion is required (e.g. by the second NF node 30), then it has to be included in the first request. The first request 614 may also comprise the access token if this is required. However, if token-based authorisation is not required, then the access token does not need to be granted by the NRF node 60 and does not need to be sent to the second NF node 30. As illustrated by block 616 of FIG. 8, the second NF node 30 checks the received security features, namely the client credentials assertion and/or the access token. That is, the second NF node 30 authenticates the received security features. If the authentication is successful, the second NF node 30 accepts (or validates) the received security features.

As illustrated by arrow 618 of FIG. 8, the second NF node 30 initiates transmission of a response to the first request towards the first SCP node 10. The response 618 to the first request can be indicative of whether the first request is allowed. The first request may be allowed provided that one or more of the security features of the first request are accepted (or validated) by the second NF node 30. For example, if the access token is required, access to the first service 40 requested by the first NF node 20 will only be allowed if the access token is granted. As illustrated by arrow 620 of FIG. 8, the first SCP node 10 initiates transmission of the response to the first request towards the first NF node 20. In some embodiments, the response 618, 620 to the first request may have a second security feature only if such a second security feature is required. The second security feature can, for example, be the client credentials assertion, the access token, and/or any other security feature. The second NF node 30 or the first SCP node 10 may be responsible for including a second security feature in and/or applying a second security feature to the response. As illustrated by block 622 of FIG. 8, the process may the continue in the usual manner.

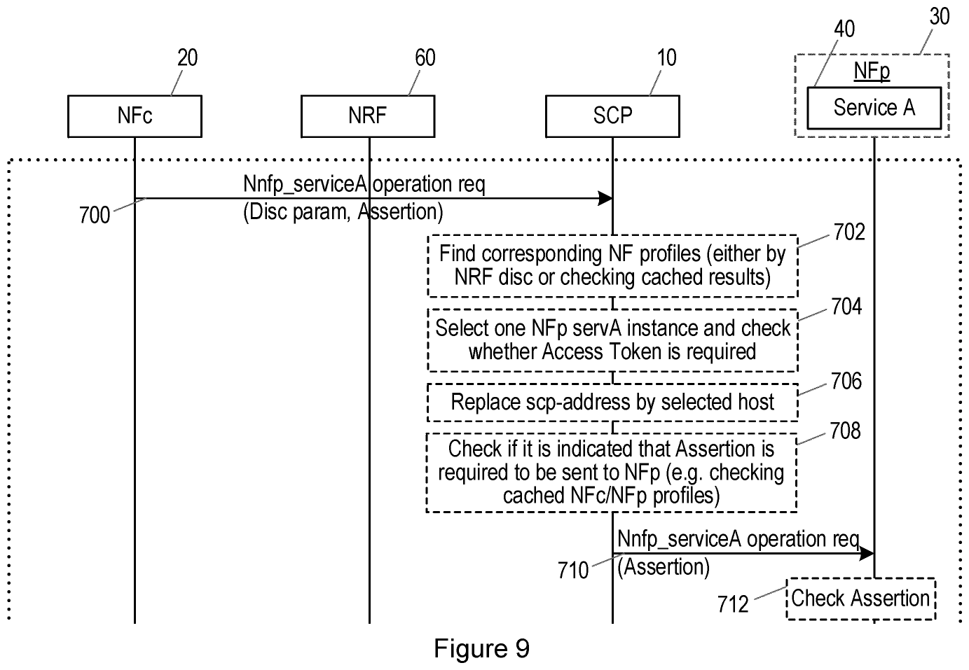

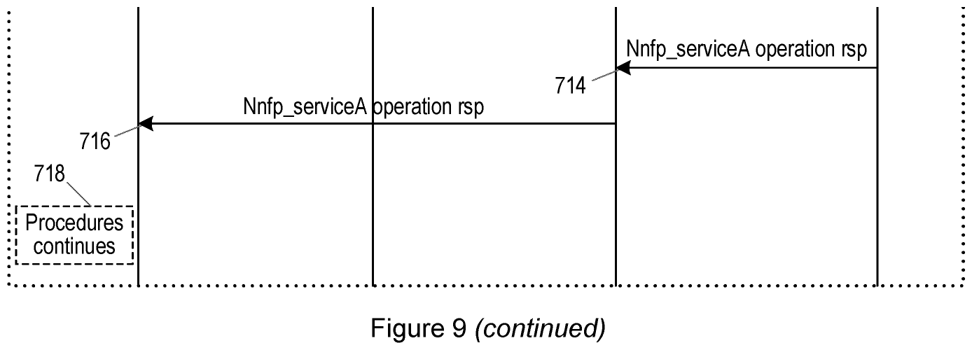

FIG. 9 is a signalling diagram illustrating an exchange of signals in a system according to an embodiment. The system illustrated in FIG. 9 comprises a first SCP node 10, a first NF node 20 of a service consumer (“NFc”), and a second NF node 30 of a service producer (“NFp”). The first SCP node 10 is configured to operate as an SCP between the first NF node 20 and the second NF node 30. Although only a single second NF node 30 is illustrated in FIG. 9, it will be understood that there may be a single second NF node or a plurality of second NF nodes. Thus, the first SCP node 10 can be configured to operate as an SCP between the first NF node 20 and one or more second NF nodes.

The first SCP node 10 and/or the first NF node 20 can be as described earlier with reference to FIGS. 3 and 4. The second NF node 30 can be as described earlier with reference to FIGS. 5 and 6. The second NF node 30 can be configured to run (or provide) a first service 40. In some embodiments, the second NF node 30 can be part of a set (or group) of NF nodes comprising a plurality of NF nodes of the service producer. The system illustrated in FIG. 9 comprises a network repository function (NRF) node 60. In some embodiments, an entity may comprise the first SCP node 10 and the NRF node 60. That is, in some embodiments, the first SCP node 10 can be merged with the NRF node 60 in a combined entity.

In some embodiments, the first SCP node 10 and the first NF node 20 may be deployed in independent deployment units, and/or the first SCP node 10 and the second NF node 30 may be deployed in independent deployment units. Thus, an SCP node based on independent deployment units is possible, as described in 3GPP TS 23.501 V16.4.0. In other embodiments, the first SCP node 10 may be deployed as a distributed network element. For example, in some embodiments, part (e.g. a service agent) of the first SCP node 10 may be deployed in the same deployment unit as the first NF node 20, and/or part (e.g. a service agent) of the first SCP node 10 may be deployed in the same deployment unit as the second NF node 30. Thus, an SCP node based on a service mesh is possible, as described in 3GPP TS 23.501 V16.4.0.

In some embodiments, at least one second SCP node may be configured to operate as an SCP between the first NF node 20 and the first SCP node 10, and/or at least one third SCP node may be configured to operate as an SCP between the first SCP node and the second NF node 30. Thus, a multipath of SCP nodes is possible. In some of these embodiments, the first SCP node 10 and one or more of the at least one second SCP node and the at least one third SCP node may be deployed in independent deployment units. In some embodiments, the at least one second SCP node and/or the at least one third SCP node may be deployed as distributed network elements.

FIG. 9 relates to a request for a service, which may be for a specific user equipment (UE) and/or session context. As illustrated by arrow 700 of FIG. 9, the first NF node initiates transmission of the service request towards the first SCP node 10. The service request 700 is for an NF node of the service producer to provide a service requested by the first NF node 20. The first NF node 20 may know via which SCP node to route the service request 700 by configuration or other means. The service request 700 can comprise the address of this SCP node. In this illustration, this SCP node is the first SCP node 10. The discovery parameters described earlier with reference to FIG. 7 may be included in the service request 700. For example, the service request 700 can comprise a hypertext transfer protocol (HTTP) header that identifies the parameters to be used for discovery (and selection). The service request 700 has a security feature, which is that the service request 700 comprises a client credentials assertion.

As illustrated by block 702 of FIG. 9, the first SCP node 10 may find corresponding NF profile(s) of one or more NF nodes of the service producer, e.g. either by discovery with the NRF node 60 as described earlier with reference to FIG. 7 or by checking the results that may have been stored earlier. As illustrated by block 704 of FIG. 9, the first SCP node 10 may select one NF node of the service producer, such as from the one(s) discovered using, for example, functional criteria (e.g. subscription permanent identifier (SUPI), network slice selection assistance information (NSSAI), data network name (DNN), etc.) and/or non-functional criteria (e.g. load, capacity, etc.). However, in other embodiments, the first NF node 20 may itself select an NF node of the service producer. For the purpose of the illustration, it is assumed that the second NF node 30 is selected. As also illustrated by block 704 of FIG. 9, the first SCP node may check whether a security feature is required, e.g. by the second NF node 30 (such as from a profile of the second NF node 30), for all NF nodes of the service consumer (or at least the first NF node 20), and/or for all services (or at least the first service 40). In the embodiment illustrated in FIG. 9, this security feature is an access token and it is not required. As such, an access token request towards the NRF node is not required and the access token is not sent to the second NF node 30, nor is it checked by the second NF node 30.

As illustrated by block 706 of FIG. 9, the first SCP node 10 may replace its own address (namely, the scp-address) in the service request 700 with the address of the selected second NF node 30. As illustrated by block 708 of FIG. 9, the first SCP node 10 may check whether another security feature is required. In the embodiment illustrated in FIG. 9, this security feature is client credentials assertion. The first SCP node 10 may check whether the client credentials assertion is required by the second NF node 30. The check can be based on the information comprised in a profile of the second NF node 30 and/or a profile of the first NF node 20. If the profile of the second NF node 30 and/or the profile of the first NF node 20 comprises information indicative that such a security feature is required, then the first SCP node 10 knows that the client credentials assertion is required for the service request. Alternatively or in addition, the first SCP node 10 may be configured with information that enables identification of whether the client credentials assertion is required. In the embodiment illustrated in FIG. 9, the client credentials assertion is required.

Thus, as illustrated by arrow 710 of FIG. 9, the first SCP node 10 initiates transmission of the service request towards the second NF node 30 and this service request 710 comprises the client credentials assertion. This service request is referred to herein as the “first request”. As illustrated by block 712 of FIG. 9, the second NF node 30 checks the received security feature, namely the client credentials assertion. That is, the second NF node 30 authenticates the received security feature. If the authentication is successful, the second NF node 30 accepts (or validates) the received security feature.

As illustrated by arrow 714 of FIG. 9, the second NF node 30 initiates transmission of a response to the first request towards the first SCP node 10. The response 714 to the first request can be indicative of whether the first request is allowed. The first request may be allowed provided that the security feature of the first request is accepted (or validated) by the second NF node 30. As illustrated by arrow 716 of FIG. 9, the first SCP node 10 initiates transmission of the response to the first request towards the first NF node 20. In some embodiments, the response 714, 716 to the first request may have a second security feature only if such a second security feature is required. The second security feature can, for example, be the client credentials assertion, an access token, and/or any other security feature. The second NF node 30 or the first SCP node may be responsible for including a second security feature in and/or applying a second security feature to the response. As illustrated by block 718 of FIG. 9, the process may the continue in the usual manner.

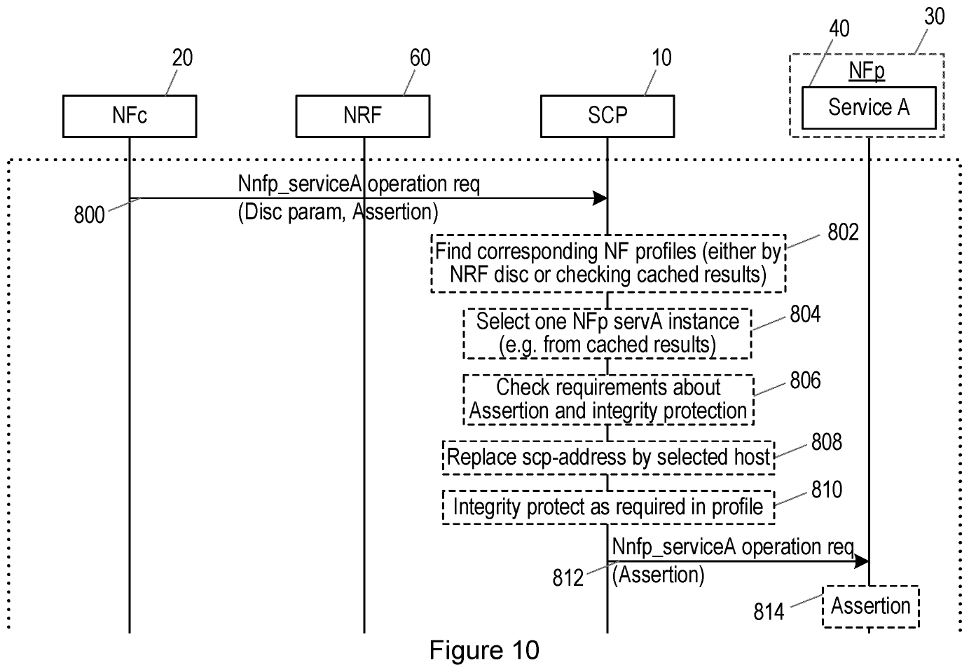

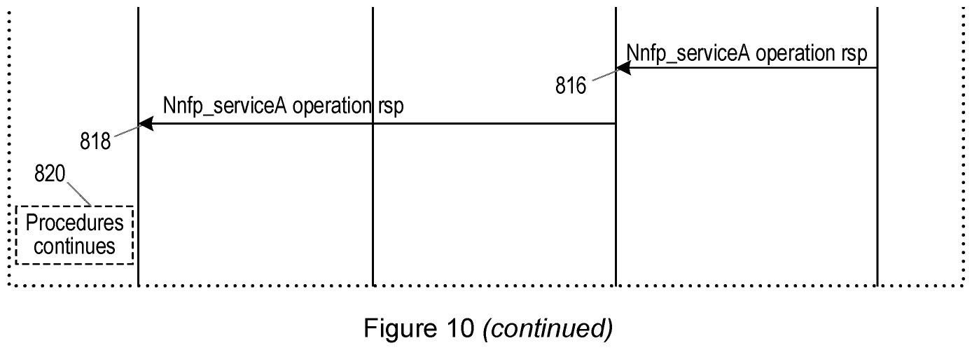

FIG. 10 is a signalling diagram illustrating an exchange of signals in a system according to an embodiment. The system illustrated in FIG. 10 comprises a first SCP node 10, a first NF node 20 of a service consumer (“NFc”), and a second NF node 30 of a service producer (“NFp”). The first SCP node 10 is configured to operate as an SCP between the first NF node 20 and the second NF node 30. Although only a single second NF node 30 is illustrated in FIG. 10, it will be understood that there may be a single second NF node or a plurality of second NF nodes. Thus, the first SCP node 10 can be configured to operate as an SCP between the first NF node 20 and one or more second NF nodes.

The first SCP node 10 and/or the first NF node 20 can be as described earlier with reference to FIGS. 3 and 4. The second NF node 30 can be as described earlier with reference to FIGS. 5 and 6. The second NF node 30 can be configured to run (or provide) a first service 40. In some embodiments, the second NF node 30 can be part of a set (or group) of NF nodes comprising a plurality of NF nodes of the service producer. The system illustrated in FIG. 10 comprises a network repository function (NRF) node 60. In some embodiments, an entity may comprise the first SCP node 10 and the NRF node 60. That is, in some embodiments, the first SCP node 10 can be merged with the NRF node 60 in a combined entity.

In some embodiments, the first SCP node 10 and the first NF node 20 may be deployed in independent deployment units, and/or the first SCP node 10 and the second NF node 30 may be deployed in independent deployment units. Thus, an SCP node based on independent deployment units is possible, as described in 3GPP TS 23.501 V16.4.0. In other embodiments, the first SCP node 10 may be deployed as a distributed network element. For example, in some embodiments, part (e.g. a service agent) of the first SCP node 10 may be deployed in the same deployment unit as the first NF node 20, and/or part (e.g. a service agent) of the first SCP node 10 may be deployed in the same deployment unit as the second NF node 30. Thus, an SCP node based on a service mesh is possible, as described in 3GPP TS 23.501 V16.4.0.

In some embodiments, at least one second SCP node may be configured to operate as an SCP between the first NF node 20 and the first SCP node 10, and/or at least one third SCP node may be configured to operate as an SCP between the first SCP node and the second NF node 30. Thus, a multipath of SCP nodes is possible. In some of these embodiments, the first SCP node 10 and one or more of the at least one second SCP node and the at least one third SCP node may be deployed in independent deployment units. In some embodiments, the at least one second SCP node and/or the at least one third SCP node may be deployed as distributed network elements.

FIG. 10 relates to a request for a service, which may be for a specific user equipment (UE) and/or session context. As illustrated by arrow 800 of FIG. 10, the first NF node initiates transmission of the service request towards the first SCP node 10. The service request 800 is for an NF node of the service producer to provide a service requested by the first NF node 20. The first NF node 20 may know via which SCP node to route the service request 800 by configuration or other means. The service request 800 can comprise the address of this SCP node. In this illustration, this SCP node is the first SCP node 10. The discovery parameters described earlier with reference to FIG. 7 may be included in the service request 800. For example, the service request 800 can comprise a hypertext transfer protocol (HTTP) header that identifies the parameters to be used for discovery (and selection). The service request 800 has a security feature, which is that the service request 800 comprises a client credentials assertion.

As illustrated by block 802 of FIG. 10, the first SCP node 10 may find corresponding NF profile(s) of one or more NF nodes of the service producer, e.g. either by discovery with the NRF node 60 as described earlier with reference to FIG. 7 or by checking the results that may have been stored earlier. As illustrated by block 804 of FIG. 10, the first SCP node 10 may select one NF node of the service producer, such as from results stored earlier. However, in other embodiments, the first NF node 20 may itself select an NF node of the service producer. For the purpose of the illustration, it is assumed that the second NF node 30 is selected. As illustrated by block 806 of FIG. 10, the first SCP node 10 may check whether a security feature is required, e.g. by the second NF node 30 (such as from a profile of the second NF node 30), for all NF nodes of the service consumer (or at least the first NF node 20), and/or for all services (or at least the first service 40). More specifically, in the embodiment illustrated in FIG. 10, the first SCP node 10 checks whether the security features of client credentials assertion and integrity protection are required. However, it will be understood that any other security feature and any combination of security features may be checked. The check can be based on information comprised in a profile of the second NF node 30 and/or a profile of the first NF node 20. Alternatively or in addition, the first SCP node may be configured with information that enables identification of whether any security features are required. In the embodiment illustrated in FIG. 10, the client credentials assertion and integrity protection are required.

As illustrated by block 808 of FIG. 10, the first SCP node 10 may replace its own address (namely, the scp-address) in the service request 800 with the address of the selected second NF node 30. As illustrated by block 810 of FIG. 10, the first SCP node 10 integrity protects the service request as it is required. Alternatively, the first NF node 20 may integrity protect the service request. The node that integrity protects the service request may be determined by configuration or information in one or more of the profiles mentioned earlier. The whole of the service request or only part (e.g. the body, one or more headers and/or fields, or a hash of part) of the service request may be integrity protected. The extent to which the service request if integrity protected may be determined by configuration or information in one or more of the profiles mentioned earlier.

As illustrated by arrow 812 of FIG. 10, the first SCP node 10 initiates transmission of the integrity protected service request towards the second NF node 30 and this service request 812 comprises the client credentials assertion. This service request is referred to herein as the “first request”. As illustrated by block 814 of FIG. 10, the second NF node 30 checks the received security feature, namely the client credentials assertion. That is, the second NF node 30 authenticates the received security feature. If the authentication is successful, the second NF node 30 accepts (or validates) the received security feature. Also, as at least part of the service request is integrity protected, the second NF node 30 can check that the service request has not been modified.

As illustrated by arrow 816 of FIG. 10, the second NF node 30 initiates transmission of a response to the first request towards the first SCP node 10. The response 816 to the first request can be indicative of whether the first request is allowed. The first request may be allowed provided that the security feature of the first request is accepted (or validated) by the second NF node 30 and/or provided the first request has not been modified. As illustrated by arrow 818 of FIG. 10, the first SCP node 10 initiates transmission of the response to the first request towards the first NF node 20. In some embodiments, the response 816, 818 to the first request may have a second security feature only if such a second security feature is required. The second security feature can, for example, be the integrity protection, the client credentials assertion, an access token, and/or any other security feature. The second NF node 30 or the first SCP node 10 may be responsible for including a second security feature in and/or applying a second security feature to the response. As illustrated by block 820 of FIG. 10, the process may the continue in the usual manner.

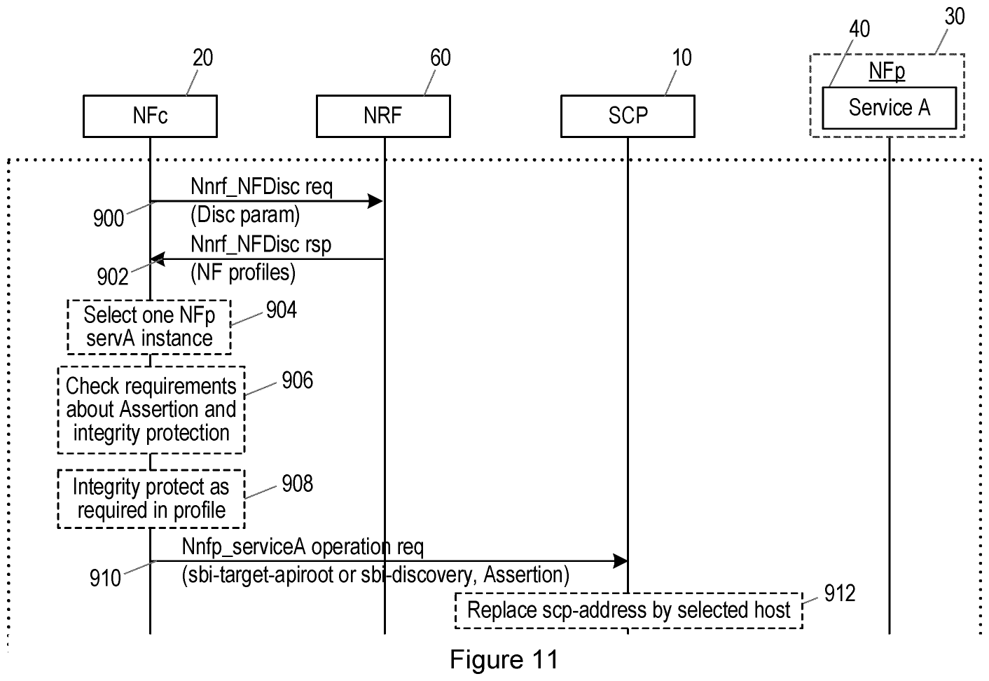

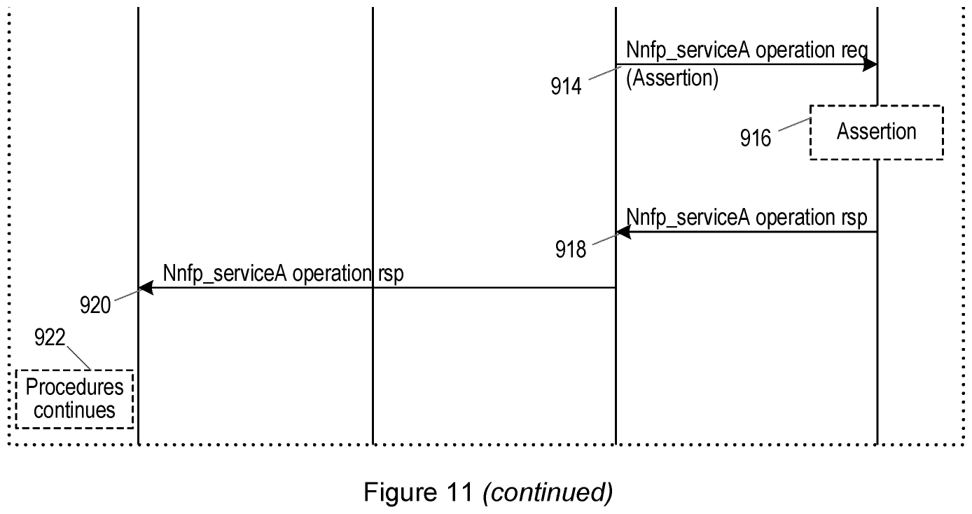

FIG. 11 is a signalling diagram illustrating an exchange of signals in a system according to an embodiment. The system illustrated in FIG. 11 comprises a first SCP node 10, a first NF node 20 of a service consumer (“NFc”), and a second NF node 30 of a service producer (“NFp”). The first SCP node 10 is configured to operate as an SCP between the first NF node 20 and the second NF node 30. Although only a single second NF node 30 is illustrated in FIG. 11, it will be understood that there may be a single second NF node or a plurality of second NF nodes. Thus, the first SCP node 10 can be configured to operate as an SCP between the first NF node 20 and one or more second NF nodes.

The first SCP node 10 and/or the first NF node 20 can be as described earlier with reference to FIGS. 3 and 4. The second NF node 30 can be as described earlier with reference to FIGS. 5 and 6. The second NF node 30 can be configured to run (or provide) a first service 40. In some embodiments, the second NF node 30 can be part of a set (or group) of NF nodes comprising a plurality of NF nodes of the service producer. The system illustrated in FIG. 11 comprises a network repository function (NRF) node 60. In some embodiments, an entity may comprise the first SCP node 10 and the NRF node 60. That is, in some embodiments, the first SCP node 10 can be merged with the NRF node 60 in a combined entity.

In some embodiments, the first SCP node 10 and the first NF node 20 may be deployed in independent deployment units, and/or the first SCP node 10 and the second NF node 30 may be deployed in independent deployment units. Thus, an SCP node based on independent deployment units is possible, as described in 3GPP TS 23.501 V16.4.0. In other embodiments, the first SCP node 10 may be deployed as a distributed network element. For example, in some embodiments, part (e.g. a service agent) of the first SCP node 10 may be deployed in the same deployment unit as the first NF node 20, and/or part (e.g. a service agent) of the first SCP node 10 may be deployed in the same deployment unit as the second NF node 30. Thus, an SCP node based on a service mesh is possible, as described in 3GPP TS 23.501 V16.4.0.

In some embodiments, at least one second SCP node may be configured to operate as an SCP between the first NF node 20 and the first SCP node 10, and/or at least one third SCP node may be configured to operate as an SCP between the first SCP node and the second NF node 30. Thus, a multipath of SCP nodes is possible. In some of these embodiments, the first SCP node 10 and one or more of the at least one second SCP node and the at least one third SCP node may be deployed in independent deployment units. In some embodiments, the at least one second SCP node and/or the at least one third SCP node may be deployed as distributed network elements.

FIG. 11 relates to a request for a service, which may be for a specific user equipment (UE) and/or session context. As illustrated by arrows 900 and 902 of FIG. 11, a discovery process can be performed between the first NF node 20 and the NRF node 60. For example, as illustrated by arrow 900 of FIG. 11, the discovery process can involve the first NF node 20 initiating transmission of a discovery request towards the NRF node 60 to obtain NF profile(s) of one or more NF nodes of the service producer for the first service that needs to be provided. The discovery request comprises the discovery parameters. As illustrated by arrow 902 of FIG. 11, the first NF node 20 receives a response from the NRF node 60 comprising the NF profile(s) of one or more NF nodes of the service producer.

Although not illustrated in FIG. 11, the first NF node 20 may store the NF profile(s) of one or more NF nodes of the service producer. As illustrated by block 904 of FIG. 11, the first NF node 20 may select one NF node of the service producer from the one(s) discovered using, for example, functional criteria (e.g. subscription permanent identifier (SUPI), network slice selection assistance information (NSSAI), data network name (DNN), etc.) and/or non-functional criteria (e.g. load, capacity, etc.). However, in other embodiments, the first SCP node 10 may perform discovery and select an NF node of the service producer. For the purpose of the illustration, it is assumed that the second NF node 30 is selected.

As illustrated by block 906 of FIG. 11, the first NF node 20 may check whether a security feature is required, e.g. by the second NF node 30 (such as from a profile of the second NF node 30), for all NF nodes of the service consumer (or at least the first NF node 20), and/or for all services (or at least the first service 40). More specifically, in the embodiment illustrated in FIG. 11, the first NF node 20 checks whether the security features of client credentials assertion and integrity protection are required. However, it will be understood that any other security feature and any combination of security features may be checked. The check can be based on information comprised in a profile of the second NF node 30 and/or a profile of the first NF node 20. Alternatively or in addition, the first NF node 20 may be configured with information that enables identification of whether any security features are required. In the embodiment illustrated in FIG. 11, the client credentials assertion and integrity protection are required.

As illustrated by block 908 of FIG. 11, the first NF node 20 integrity protects the service request as it is required. Alternatively, the first SCP node 10 may integrity protect the service request. The node that integrity protects the service request may be determined by configuration or information in one or more of the profiles mentioned earlier. The whole of the service request or only part (e.g. the body, one or more headers and/or fields, or a hash of part) of the service request may be integrity protected. The extent to which the service request if integrity protected may be determined by configuration or information in one or more of the profiles mentioned earlier.

As illustrated by arrow 910 of FIG. 11, the first NF node 20 initiates transmission of the integrity protected service request towards the first SCP node 10 and this service request 910 comprises the client credentials assertion. This service request 910 is referred to herein as the “first request”. The first request 910 may also comprise an identifier that identifies the second NF node 30 or information that enables the first SCP node 10 to discover the second NF node 30. The first request 910 is for the second NF node 30 to provide a first service 40 requested by the first NF node 20. The first NF node 20 may know via which SCP node to route the service request 910 by configuration or other means. The first request 910 can comprise the address of this SCP node. In this illustration, this SCP node is the first SCP node 10. As illustrated by block 912 of FIG. 11, the first SCP node 10 may replace its own address (namely, the scp-address) in the first request 910 with the address of the selected second NF node 30.

As illustrated by arrow 914 of FIG. 11, the first SCP node 10 initiates transmission of the integrity protected first request towards the second NF node 30 and this first request 914 comprises the client credentials assertion. As illustrated by block 916 of FIG. 11, the second NF node 30 checks the received security feature, namely the client credentials assertion. That is, the second NF node 30 authenticates the received security feature. If the authentication is successful, the second NF node 30 accepts (or validates) the received security feature. Also, as at least part of the service request is integrity protected, the second NF node 30 can check that the service request has not been modified.

As illustrated by arrow 918 of FIG. 11, the second NF node 30 initiates transmission of a response to the first request towards the first SCP node 10. The response 918 to the first request can be indicative of whether the first request is allowed. The first request may be allowed provided that the security feature of the first request is accepted (or validated) by the second NF node 30 and/or provided that the first request has not been modified. As illustrated by arrow 920 of FIG. 11, the first SCP node 10 initiates transmission of the response to the first request towards the first NF node 20. In some embodiments, the response 918, 920 to the first request may have a second security feature only if such a second security feature is required. The second security feature can, for example, be the integrity protection, the client credentials assertion, an access token, and/or any other security feature. The second NF node 30 or the first SCP node 10 may be responsible for including a second security feature in and/or applying a second security feature to the response. As illustrated by block 922 of FIG. 11, the process may the continue in the usual manner.

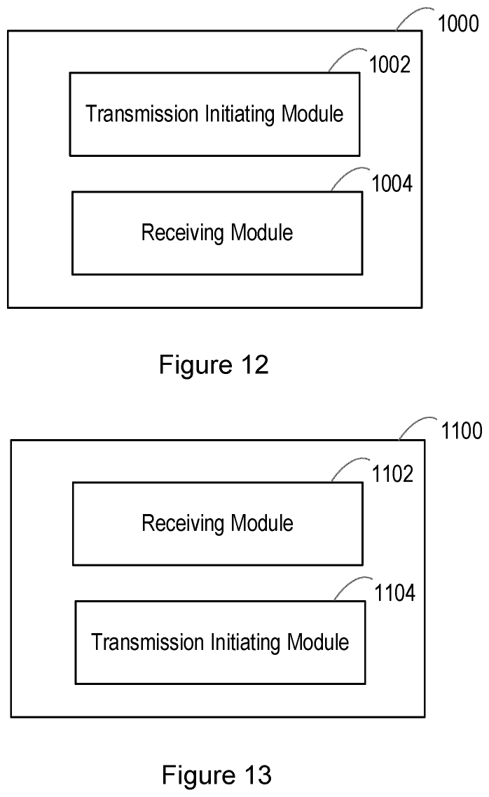

FIG. 12 is a block diagram illustrating a first network node 1000 in accordance with an embodiment. The first network node 1000 can handle a service request in a network. The first network node 1000 is a first NF node of a service consumer or a SCP node that is configured to operate as an SCP between the first NF node and a second NF node of a service producer. The first network node 1000 comprises a transmission initiating module 1002 configured to initiate transmission of a first request. The first request is for the second NF node to provide a first service requested by the first NF node. The first request has a first security feature only if such a first security feature is required. Alternatively or in addition, the first network node 1000 comprises a receiving module 1004 configured to receive a response to the first request. The response to the first request has a second security feature only if such a second security feature is required. The first network node 1000 may operate in the manner described herein in respect of the first network node.

FIG. 13 is a block diagram illustrating a second NF node 1100 in accordance with an embodiment. The second NF node 1100 can handle a service request in a network. The second NF node 1100 comprises a receiving module 1102 configured to receive a first request for the second NF node to provide a service requested by a first NF node of a service consumer. The first request has a first security feature only if such a first security feature is required. Alternatively or in addition, the second NF node 1100 comprises a transmission initiating module 1104 configured to initiate transmission of a response to the first request towards a first network node 1000. The first network node 1000 is the first NF node or a first SCP node that is configured to operate as an SCP between the first NF node and the second NF node 1100. The response to the first request has a second security feature only if such a second security feature is required. The second NF node 1100 may operate in the manner described herein in respect of the second NF node.

There is also provided a computer program comprising instructions which, when executed by processing circuitry (such as the processing circuitry 12 of the first network node 10, 20 described earlier and/or the processing circuitry 32 of the second NF node described earlier), cause the processing circuitry to perform at least part of the method described herein. There is provided a computer program product, embodied on a non-transitory machine-readable medium, comprising instructions which are executable by processing circuitry (such as the processing circuitry 12 of the first network node 10, 20 described earlier and/or the processing circuitry 32 of the second NF node 30 described earlier) to cause the processing circuitry to perform at least part of the method described herein. There is provided a computer program product comprising a carrier containing instructions for causing processing circuitry (such as the processing circuitry 12 of the first network node 10, 20 described earlier and/or the processing circuitry 32 of the second NF node 30 described earlier) to perform at least part of the method described herein. In some embodiments, the carrier can be any one of an electronic signal, an optical signal, an electromagnetic signal, an electrical signal, a radio signal, a microwave signal, or a computer-readable storage medium.

In some embodiments, the first network node functionality and/or the second NF node functionality described herein can be performed by hardware. Thus, in some embodiments, any one or more of the first network node 10, 20 and the second NF node 30 described herein can be a hardware node. However, it will also be understood that optionally at least part or all of the first network node functionality and/or the second NF node functionality described herein can be virtualized. For example, the functions performed by any one or more of the first network node 10, 20 and the second NF node 30 described herein can be implemented in software running on generic hardware that is configured to orchestrate the node functionality. Thus, in some embodiments, any one or more of the first network node 10, 20 and the second NF node 30 described herein can be a virtual node. In some embodiments, at least part or all of the first network node functionality and/or the second NF node functionality described herein may be performed in a network enabled cloud. The first network node functionality and/or the second NF node functionality described herein may all be at the same location or at least some of the node functionality may be distributed.

It will be understood that at least some or all of the method steps described herein can be automated in some embodiments. That is, in some embodiments, at least some or all of the method steps described herein can be performed automatically. The method described herein can be a computer-implemented method.

Thus, in the manner described herein, there are advantageously provided improved techniques for handling service requests in a network. By the first request having a first security feature only when such a first security feature is required and/or the response having a second security feature only when such a second security feature is required, this avoids the need for the first request and/or the response always having a security feature. In this way, the resources used to employ such security features can be conserved and the efficiency of the overall system can be improved, whilst still maintaining an appropriate level of security.

It should be noted that the above-mentioned embodiments illustrate rather than limit the idea, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1-54. (canceled)

55. A method for handling a service request in a network, wherein the method is performed by a first network node, wherein the first network node is a first network function (NF) node of a service consumer or a first service communication proxy (SCP) node that is operable to operate as an SCP between the first NF node and a second NF node of a service producer, the method comprising:
initiating transmission of a first request, wherein the first request is for the second NF node to provide a first service requested by the first NF node, wherein the first request has a first security feature only if such a first security feature is required; and/or
receiving a response to the first request, wherein the response to the first request has a second security feature only if such a second security feature is required.

56. The method of claim 55, wherein
the first security feature is that the first request comprises at least one first security parameter and/or at least part of the first request is protected by a first security protocol, and/or
the second security feature is that the response to the first request comprises at least one second security parameter and/or at least part of the response to the first request is protected by a second security protocol.

57. The method of claim 56, wherein
the at least one first security parameter comprises at least one first security token and/or the first security protocol is encryption and/or integrity protection, and/or
the at least one second security parameter comprises at least one second security token and/or the second security protocol is encryption and/or integrity protection.

58. The method of claim 57, wherein
the at least one first security token comprises at least one first client credentials assertion and/or at least one first access token, and/or
the at least one second security token comprises at least one second client credentials assertion and/or at least one second access token.

59. The method of claim 55, wherein
the first and/or second security feature is required by:
the first SCP node;
a group of SCP nodes comprising the first SCP node;
the second NF node;
a group of NF nodes of the service producer comprising the second NF node;
a network repository function (NRF) node; and/or
any other node,
the first and/or second security feature is required for:
all services;
any service requested by the first NF node;
the first service requested by the first NF node;
a group of services comprising the first service requested by the first NF node; or
services that are outside a predefined location and the first service is outside the predefined location, and/or
the first and/or second security feature is required for:
all NF nodes of the service consumer;
the first NF node of the service consumer;
a group of NF nodes of the service consumer comprising the first NF node of the service consumer; or
any NF nodes of the service consumer that are outside a predefined location and the first NF node of the service consumer is outside the predefined location.

60. The method of claim 59, wherein
the first security feature is required by the second NF node for the first request, and/or
the first security feature is required by the NRF node for a request for the NRF node to provide an access token.

61. The method of claim 55, wherein
the first request has the first security feature if a profile of the second NF node comprises information indicative that such a first security feature is required and/or if the first NF node is configured in a predefined way that requires the first security feature, and/or
the response to the first request has the second security feature if a profile of the second NF node comprises information indicative that such a second security feature is required.

62. The method of claim 55, the method comprising:
checking whether such a first and/or second security feature is required; and/or
receiving a message comprising information indicative of whether such a first and/or second security feature is required.

63. The method of claim 62, wherein the message comprises information indicative of one or more nodes that require such a first and/or second security feature.

64. The method of claim 62, wherein
the method is performed by the first NF node;
the first request is a subsequent request for the second NF node to provide the first service requested by the first NF node; and
the message is a response to an earlier request for the second NF node to provide the first service requested by the first NF node; or
the method is performed by the first SCP node; and
the message is a response to a request for a network repository function (NRF) node to provide an access token.

65. A first network node, comprising:
a transmitter;
a receiver; and
processing circuitry configured to cause the first network node to perform the method of claim 55.

66. A method for handling a service request in a network, wherein the method is performed by a second network node of a service producer, the method comprising:
receiving a first request for the second network node to provide a service requested by a first NF node of a service consumer, wherein the first request has a first security feature only if such a first security feature is required; and/or
initiating transmission of a response to the first request towards a first network node, wherein the first network node is the first NF node or a first service communication proxy (SCP) node that is operable to operate as an SCP between the first NF node and the second network node, and wherein the response to the first request has a second security feature only if such a second security feature is required.

67. The method of claim 66, wherein the response to the first request is indicative of whether the first request is allowed.

68. The method of claim 67, wherein the first request is allowed provided that the first security feature of the first request is accepted by the second network node.

69. The method of claim 66, wherein
the first security feature is that the first request comprises at least one first security parameter and/or at least part of the first request is protected by a first security protocol, and/or
the second security feature is that the response to the first request comprises at least one second security parameter and/or at least part of the response to the first request is protected by a second security protocol.

70. The method of claim 69, wherein
the at least one first security parameter comprises at least one first security token and/or the first security protocol is encryption and/or integrity protection, and/or
the at least one second security parameter comprises at least one second security token and/or the second security protocol is encryption and/or integrity protection.

71. The method of claim 70, wherein
the at least one first security token comprises at least one first client credentials assertion and/or at least one first access token, and/or
the at least one second security token comprises at least one second client credentials assertion and/or at least one second access token.

72. The method of claim 66, wherein
the first and/or second security feature is required by:
the first SCP node;
a group of SCP nodes comprising the first SCP node;
the second network node;
a group of NF nodes of the service producer comprising the second network node;
a network repository function (NRF) node; and/or
any other node,
the first and/or second security feature is required for:
all services;
any service requested by the first NF node;
the first service requested by the first NF node;
a group of services comprising the first service requested by the first NF node; or
services that are outside a predefined location and the first service is outside the predefined location, and/or
the first and/or second security feature is required for:
all NF nodes of the service consumer;
the first NF node of the service consumer;
a group of NF nodes of the service consumer comprising the first NF node of the service consumer; or
any NF nodes of the service consumer that are outside a predefined location and the first NF node of the service consumer is outside the predefined location.

73. The method of claim 72, wherein
the first security feature is required by the second network node for the first request, and/or
the first security feature is required by the NRF node for a request for the NRF node to provide an access token.

74. The method of claim 66, wherein
the first request has the first security feature if a profile of the second network node comprises information indicative that such a first security feature is required and/or if the first NF node is configured in a predefined way that requires the first security feature, and/or
the response to the first request has the second security feature if a profile of the second network node comprises information indicative that such a second security feature is required.

75. A second network function (NF) node of a service producer, comprising:
a transmitter;
a receiver; and
processing circuitry configured the second NF to perform the method of claim 66.

76. A non-transitory computer readable storage medium storing a computer program comprising instructions which, when executed by processing circuitry of a network node causes the network node to perform the method of claim 55.

77. A non-transitory computer readable storage medium storing a computer program comprising instructions which, when executed by processing circuitry of a network node causes the network node to perform the method of claim 66.
